(19) United States
(12) Patent Application Publication
(10) Pub. No.: US 2026/0009948 A1
(43) Pub. Date: Jan. 8, 2026

(54) MULTl-LAYER OPTICAL INTERPOSER

(71) Applicant: PsiQuantum, Corp., Palo Alto, CA (US)

(72) Inventors: Mark G. Thompson, Chester (GB); Gabriel Mendoza, Mountain View, CA (US)

(21) Appl. No.: 19/121,098

(22) PCT Filed: Oct. 12, 2023
(86) PCT No.: PCT/US2023/076744

§ 371 Date: Apr. 14, 2025

Related U.S. Application Data
(60) Provisional application No. 63/379,267, filed on Oct. 12, 2022.

(51) Int. Cl. G02B 6/122

(52) U.S. Cl. CPC G02B 6/1228

(57) ABSTRACT

An optical interposer includes multi-layer coupled waveguides for optically coupling between photonic integrated circuit devices, providing low-loss optical delays, coupling photons (e.g., qubit states) between photonic integrated circuits and optical fibers, and the like. In some embodiments, the multi-layer coupled waveguides form a multi-layer waveguide structure with monotonically varying layer separations and waveguide thicknesses. In some embodiments, a waveguide device that includes an oxide layer and zero or more waveguide layers in the oxide layer may be bonded to the optical interposer, where optical fields of the guided modes of the waveguides in the optical interposer can extend to the waveguide device.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Photonic integrated circuits, such as silicon photonic integrated circuits, can be used in many systems, such as quantum communication systems and optical quantum computing systems. These quantum mechanics-based systems are distinguished from “classical” systems by their reliance on quantum states, such as quantum bits (qubits). To achieve the desired functions and performance, a quantum mechanics-based system may integrate many passive and active photonic devices, modules, and subsystems into the same system. For example, an optical quantum computer may need to integrate passive and active photonic integrated circuits and other optical and electrical components, such as optical fibers or other low-loss optical interconnects, control circuits, and classical processing units, into a same system, to reliably generate, manipulate (e.g., entangle), and detect hundreds, thousands, or even millions of qubits for computing and error corrections, while achieving the desired functions and performance.

### SUMMARY

Techniques disclosed herein relate generally to coupling light between photonic integrated circuits. Various inventive embodiments are described herein, including methods, processes, systems, devices, circuits, packages, modules, units, wafers, dies, networks, cells, and the like.

According to certain embodiments, a device may include an optical interposer, and a first photonic integrated circuit (PIC) die bonded to the optical interposer. The optical interposer may include a first oxide layer, and three or more optical waveguide layers in the first oxide layer. The three or more optical waveguide layers may include: a first waveguide layer including a first waveguide at a first distance below a top surface of the first oxide layer, the first waveguide characterized by a first thickness; a second waveguide layer including a second waveguide at a second distance below the first waveguide, the second waveguide characterized by a second thickness, and the second waveguide partially overlapping the first waveguide; and a third waveguide layer including a third waveguide at a third distance below the second waveguide, the third waveguide characterized by a third thickness, the third waveguide partially overlapping the second waveguide, the first thickness being greater than the second thickness, and the second thickness being greater than the third thickness. The first PIC die may include a second oxide layer and a fourth waveguide in the second oxide layer, the second oxide layer bonded to the first oxide layer, and the fourth waveguide partially overlapping the first waveguide to optically couple to the first waveguide.

According to certain embodiments, a device may include an optical interposer that includes a first oxide layer, and a first waveguide layer in the first oxide layer, the first waveguide layer including a first waveguide and a second waveguide. The device may also include: a first photonic integrated circuit (PIC) die bonded to the optical interposer and including a third waveguide optically coupled to the first waveguide; a second PIC die bonded to the optical interposer and including a fourth waveguide optically coupled to the second waveguide; and a waveguide device bonded to the optical interposer. The waveguide device may include: a second oxide layer; a second waveguide layer in the second oxide layer, the second waveguide layer including a fifth waveguide and a sixth waveguide, the fifth waveguide optically coupled to the third waveguide, and the sixth waveguide optically coupled to the fourth waveguide; and a third waveguide layer including a seventh waveguide optically coupled to one or more of: the fifth waveguide or the sixth waveguide, the seventh waveguide characterized by a guided mode having an optical field extending into the first oxide layer.

According to certain embodiments, an optical interposer may include a first oxide layer, and three or more optical waveguide layers in the first oxide layer. The three or more optical waveguide layers may include: a first waveguide layer including a first waveguide at a first distance below a top surface of the first oxide layer, the first waveguide characterized by a first thickness; a second waveguide layer including a second waveguide at a second distance below the first waveguide, the second waveguide characterized by a second thickness and partially overlapping with the first waveguide; and a third waveguide layer including a third waveguide at a third distance below the second waveguide, the third waveguide characterized by a third thickness and partially overlapping with the second waveguide, the first thickness being greater than the second thickness, and the second thickness being greater than the third thickness.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Aspects of the present disclosure are illustrated by way of example. Non-limiting and non-exhaustive aspects are described with reference to the following figures, wherein like reference numerals refer to like parts throughout the various figures unless otherwise specified.

FIG. 1A illustrates an example of a system including multiple interconnected wafer-scale modules according to certain embodiments.

FIG. 1B is a top view of an example of a wafer-scale module including multiple electronic integrated circuit (EIC)/photonic integrated circuit (PIC) die stacks on a handle wafer according to certain embodiments.

FIG. 2A illustrates an example of a subsystem for generating entangled quantum states according to certain embodiments.

FIG. 2B is a cross-sectional view of an example of a wafer-scale module in a subsystem for generating entangled quantum states according to certain embodiments.

FIG. 3A is a cross-sectional view of an example of a wafer-scale module including multiple EIC/PIC (EPIC) die stacks coupled to an optical backplane according to certain embodiments.

FIG. 3B is a zoom-in view of a portion of the example of the wafer-scale module of FIG. 3A according to certain embodiments.

FIG. 4A is a cross-sectional view of an example of a multi-layer waveguide structure of an optical interposer for coupling light between a photonic integrated circuit and an optical fiber according to certain embodiments.

FIG. 4B is a top view of the example of the multi-layer waveguide structure of FIG. 4A.

FIG. 5A is a cross-sectional view of an example of a multi-layer waveguide structure in an optical interposer according to certain embodiments.

FIG. 5B illustrates examples of coupling losses between waveguides of the multi-layer waveguide structure of FIG. 5A as a function of the coupling length.

FIG. 5C includes a diagram illustrating an example of light coupling between two waveguide layers having a first coupling length according to certain embodiments.

FIG. 5D includes a diagram illustrating another example of light coupling between two waveguide layers having a second coupling length according to certain embodiments.

FIG. 6A illustrates an example of coupling light between two photonic integrated circuits using a multi-layer optical interposer according to certain embodiments.

FIG. 6B illustrates an example of delaying light transported between two photonic integrated circuits using a multi-layer optical interposer that includes a delay waveguide according to certain embodiments.

FIG. 7 illustrates an example of a device including a multi-layer optical interposer that includes a shallow delay waveguide and an oxide layer bonded to the multi-layer optical interposer according to certain embodiments.

FIG. 8 illustrates an example of delaying light transported between two photonic integrated circuits using an optical interposer and a waveguide device bonded to the optical interposer according to certain embodiments.

FIG. 9 illustrates an example of a device including an optical interposer and a waveguide device bonded to the optical interposer for transporting and/or delaying light

between photonic integrated circuits according to certain embodiments. FIGS. 10A-10P illustrate an example of a process of fabricating an optical interposer including a multi-layer waveguide structure for coupling light between a photonic integrated

circuit and an optical fiber according to certain embodiments. FIG. 11 illustrates an example of a system including multiple wafer-scale modules coupled together through qubit interconnects and controlled by a control unit according to certain embodiments.

FIG. 12 includes a simplified block diagram of an example of a quantum computing system according to some embodiments.

FIG. 13 illustrates an example of a system for generating a large, entangled state according to some embodiments.

FIG. 14A illustrates an example of a resource state generated by a resource state generator according to some embodiments.

FIG. 14B illustrates an example of a space-like resource state fusion operation according to some embodiments.

FIG. 14C illustrates an example of a time-like resource state fusion operation according to some embodiments.

FIG. 15A includes a block diagram of an example of a network for generating entanglement structures from resource states according to some embodiments.

FIG. 15B includes a block diagram of an example of a fusion device according to certain embodiments.

FIG. 16A illustrates a schematic of an example of a circuit for generating entanglement structures from resource states using a single resource state generator and time-like fusion operations according to certain embodiments.

FIG. 16B illustrates a simplified example of generating a large, entangled state of qubits using the circuit of FIG. 16A according to certain embodiments.

FIG. 17 is a simplified diagram illustrating a spiral optical delay device and an optical path of light propagating in the optical delay device in accordance with some embodiments.

FIG. 18 is a simplified system block diagram of an example of a hybrid quantum computing system according to certain embodiments.

### DETAILED DESCRIPTION

Techniques disclosed herein relate generally to coupling light between photonic integrated circuits in optical systems such as optical quantum computers or quantum communication systems. Various inventive embodiments are described herein, including methods, processes, systems, devices, circuits, packages, modules, units, wafers, dies, networks, cells, and the like.

Quantum computing and quantum communication rely on the dynamics of quantum systems, such as photons, electrons, atoms, ions, molecules, nanostructures, and the like, which follow the rules of quantum theory. In quantum theory, the quantum state of a quantum system is described by a set of physical properties, the complete set of which is referred to as a quantum mode. A quantum mode can be defined by, for example, specifying the value (or distribution of values) of one or more properties of the quantum system. In cases where the quantum system is implemented using photons (referred to as “a photonic quantum system”), quantum modes may be defined by the frequency of the photon, the photon's position in space (e.g., which waveguide or superposition of waveguides the photon is propagating within), the associated direction of propagation (e.g., the k-vector for a photon in free space), the polarization state of the photon (e.g., the direction (horizontal or vertical) of the photon's electric and/or magnetic fields), a time window in which the photon is propagating, orbital angular momentum, and the like. For the case of photons propagating in waveguides, the state of a photon may be represented by a quantum mode of a set of discrete spatiotemporal modes. For example, the spatial mode of the photon may be determined according to the waveguide in which the photon is propagating among a finite set of discrete waveguides, whereas the temporal mode of a photon may be determined based on the time period in which the photon is present among a set of discrete time periods. Other types of quantum mode, such as polarization modes, may also be used to specify the quantum state.

Many quantum computing or quantum communication systems use quantum bits (qubits) that are each simultaneously in a coherent superposition of two states to manipulate information through quantum mechanics. Most technologies used to implement qubits have issues such as stability, decoherence, fault tolerance, and scalability issue. For example, one of the main challenges in realizing quantum computation is that decoherence and other quantum noise may destroy the information in a superposition of states in a quantum computer, and inaccuracies in quantum state transformations throughout the computation may accumulate, thus making long computations difficult. To overcome these issues, quantum error correction may be needed to achieve fault-tolerant quantum computation that can deal not only with noise on stored quantum information, but also with faulty quantum gates, faulty quantum preparation, and faulty measurements. In some systems, for the purposes of quantum error correction, many physical qubits may be used to produce an entity (referred to as a logical qubit) which behaves logically as a single qubit would in a quantum circuit or algorithm. Some quantum error correction techniques may store the information of one qubit onto a highly entangled state of multiple qubits, such as 7, 9, or more physical qubits. When more than one level of encoding is performed to provide better protection, thousands or more of physical qubits may be needed for each logical qubit. Thus, a logical qubit, such as an error-corrected photonic logical qubit or a fault tolerate photonic channel, may include many entangled physical qubits to provide the stability, error-correction, and fault tolerance needed to perform useful computations. For a quantum computer that may use many logical qubits for computing, thousands or millions of physical qubits may need to be generated, entangled, switched, and detected, which may need a large number of passive and active photonic circuits and components and electric circuits and components to implement. It can be very challenging to integrate these circuits and components into a system to achieve the desired functions and performance, such as generating and manipulating entangled qubit states, and transporting entangled qubit states reliably at low optical losses by desired time delays.

According to certain embodiments, an optical interposer (also referred to as an optical backplane) including multi-layer coupled waveguides may be used to optically couple die stacks, provide low-loss optical delays, couple photons (qubit states) between photonic integrated circuits and optical fibers, and the like. In some embodiments, the multi-layer coupled waveguides may include a multi-layer waveguide structure with monotonically varying layer separations and waveguide thicknesses, where waveguides on adjacent layers may at least partially overlap for optical mode coupling. For example, the layer separation may gradually increase from the top waveguide layer to the bottom waveguide layer, while the thickness of the waveguide layers may gradually decrease from the top waveguide layer to the bottom waveguide layer. As such, thinner waveguides, the guided modes of which may have larger optical fields, may be on deeper waveguide layers, such that the optical fields of the guide modes may be within and confined by the oxide layer of the optical interposer, thereby reducing optical losses of the waveguides. The multi-layer waveguide structure may be used to couple light from a photonic integrated circuit bonded to the optical interposer to a low-loss, long delay line, to an edge coupled optical fiber, or to another photonic integrated circuit bonded to the optical interposer.

For example, light from a PIC may be coupled into an optical interposer, and may be further coupled layer to layer by the multi-layer coupled waveguide structure down to thinner and deeper waveguide layers. The optical modes guided by thinner waveguides may have larger optical fields that may better match the optical field of the guided mode of the optical fiber. Therefore, the coupling efficiencies between the waveguides and the optical fiber, and thus the coupling efficiency between a PIC and the optical fiber, can be high.

In some embodiments, additional waveguide devices (e.g., including an oxide layer and zero or more waveguide layers in the oxide layer) may be bonded to the optical interposer. The waveguide devices bonded to the optical interposer may include one or more waveguides, such as routing waveguides and/or delay waveguides. The waveguide layers in the optical interposer or waveguide devices can be close to the bonding surface. Even if the optical fields of the guided modes of the waveguides in the optical interposer or the waveguide device are large, the optical fields may extend to the waveguide device or the optical interposer, and thus may still be within and confined by the oxide material, thereby achieving a lower loss.

Some waveguides in the optical interposer may be configured to transport a photonic quantum system that includes a photon in one of two or more quantum modes. The two or more quantum modes may include, for example, two or more different frequencies, two or more different positions (e.g., a waveguide or superposition of waveguides a photon is propagating within), two or more different directions of propagation, two or more different polarization states, two or more different time windows, two or more different orbital angular momentums, or the like. The photonic quantum system may include, for example, a single photon, a qubit, a qudit, an entangled state of qubits, or a logical qubit. The photonic integrated circuit may include a single photon source configured to generate the photon. In some embodiments, the waveguide layers may include at least one of a pair of waveguides or a waveguide configured to transport photons in two or more quantum modes.

Techniques disclosed herein can be used to disaggregate functionalities of generation and manipulation of entangled qubit states, optimize critical functions in isolation, and integrate the functions via optical interposers. Waveguides in the optical interposer may provide low-loss, path-length matched, phase-stable, and high-density optical interconnects. Thus, the optical interposer disclosed herein may be used for low-loss, chip-to-chip coupling, and may replace or reduce optical fiber connections, thereby reducing overall optical losses of the system. The optical interposer disclosed herein can also provide fast feedforward and low-latency communication between photonic integrated circuit chips due to the close proximity of the photonic integrated circuit chips bonded to the optical interposer.

As used herein, a “qubit” (or quantum bit) refers to a quantum system with an associated quantum state that can be used to encode information. A quantum state can be used to encode one bit of information if the quantum state space can be modeled as a (complex) two-dimensional vector space, with one dimension in the vector space being mapped to logical value 0 and the other to logical value 1. In contrast to classical bits, a qubit can have a state that is a superposition of logical values 0 and 1. More generally, a “qudit” can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit. Qubits (or qudits) can be implemented in a variety of quantum systems. Examples of qubits include: polarization states of photons; presence of photons in waveguides; or energy states of atoms, ions, nuclei, or photons. Other examples may include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond). A physical qubit may be a physical device that behaves as a two-state quantum system. In one example, a qubit can be “dual-rail encoded” such that the logical value of the qubit is encoded by the occupation of one of two modes of the quantum system.

As used herein, a “resource state” refers to an entangled state of a number of qubits in a non-separable entangled state (which is an entangled state that cannot be decomposed into smaller separate entangled states). In various embodiments, the number of qubits of a resource state can be a small number (e.g., two or more, or any number up to about 20) or a larger number (as large as desired).

As used herein, a “logical qubit” refers to a physical or abstract qubit that has a long enough coherence time to be usable by quantum logic gates. A logical qubit may specify how a single qubit should behave in a quantum algorithm, subject to quantum logic operations by quantum logic gates. Due to issues such as stability, decoherence, fault tolerance, and scalability associated with a physical qubit that includes a single two-state quantum system, physical qubits may not be used to reliably encode and retain information for a sufficiently long period of time to be useful. Therefore, quantum error correction may need to be used to produce scalable quantum computers, where many physical qubits may be used to create a single, error-tolerant logical qubit. Depending on the error-correction scheme used and the error rates of each physical qubit, a single logical qubit may be formed using a large number (e.g., tens, hundreds, thousands, or more) of physical qubits. As used in the following sections, the term “qubit” generally refers to a physical qubit, whereas all references to logical qubits include the qualifier “logical.”

As used herein, a “quantum system” may include particles (such as atoms, ions, nuclei, and/or photons) or engineered quantum systems, such as flux qubits, phase qubits, or charge qubits (e.g., formed from a superconducting Josephson junction), topological qubits (e.g., majorana fermions), spin qubits formed from vacancy centers (e.g., nitrogen vacancies in diamond), qubits otherwise encoded in multiple quantum systems (e.g., Gottesman-Kitaev-Preskill (GKP) encoded qubits), entangled states of qubits, and the like.

As used herein, “fusion” (or “a fusion operation” or “fusing”) refers to a two-qubit entangling measurement. A “fusion gate” is a structure that receives two input qubits, each of which is typically part of an entangled state of qubits. The fusion gate may perform a projective measurement operation on the input qubits to produce either one (e.g., in “type I fusion”) or zero (e.g., in “type II fusion”) output qubit in a manner such that the initial two entangled states of qubits are fused into a single entangled state of qubits. Fusion gates are specific examples of a general class of two-qubit entangling measurements and are particularly suited for photonic architectures.

Several illustrative embodiments will now be described with respect to the accompanying drawings. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

A system that generates, manipulates, and/or detects quantum states for optical quantum computing or optical quantum communication may need to integrate passive and active photonic integrated circuits and other optical and electrical components, such as optical fibers or other low-loss optical interconnects, control circuits, and classical processing units, into a same system, to reliably generate, manipulate (e.g., entangle), and detect hundreds, thousands, or even millions of qubits for computing and error corrections. To achieve the desired functions and performance, the passive and active photonic integrated circuits and electronic integrated circuits may need to be integrated into one or more dies, one or more wafers, or one or more subsystems.

In some implementations, a plurality of die stacks that each include a photonic integrated circuit (PIC) die and an electric integrated circuit (EIC) die may be bonded to a handle wafer, for example, by fusion bonding or oxide bonding, to form a wafer-scale module. The plurality of EIC/PIC (EPIC) die stacks may be used to, for example, generate, manipulate, and detect qubits for optical quantum computing. In some embodiments, multiple wafer-scale modules may be connected through fiber cables, free-space optical interconnects, or other optical interconnects, to form a subsystem or a system for larger scale quantum state generation, manipulation, and detection.

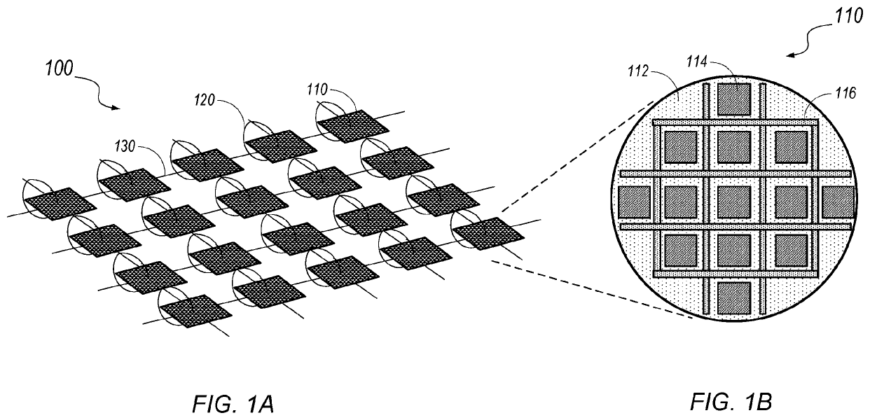

FIG. 1A illustrates an example of a system 100 including multiple wafer-scale modules 110 interconnected using optical fibers according to certain embodiments. Each wafer-scale module 110 may include multiple EPIC die stacks. Optical fibers may be used to provide inter-wafer and/or intra-wafer optical interconnects. For example, optical fibers 120 may be used to connect EPIC die stacks 114 on a same wafer-scale module 110, while optical fibers 130 may be used as interconnects between wafer-scale modules 110. System 100 may be used to perform, for example, qubit generation, manipulation, and/or detection at a larger scale.

FIG. 1B is a top view of an example of a wafer-scale module 110 including multiple EPIC die stacks 114 on a handle wafer 112 according to certain embodiments. EPIC die stacks 114 may each include a PIC die and an EIC die, and may be manufactured and bonded to handle wafer 112 (e.g., including an optical backplane or another optical interposer) as described above and below. An EPIC die stack 114 may be optically connected to another EPIC die stack 114 through one or more optical fibers, one or more optical waveguides in the optical interposer, one or more free-space optical interconnects, or other optical interconnects. Wafer-scale module 110 may also include a plurality of PCBs 116. The EIC dies in EPIC die stacks 114 may be electrically connected to PCBs 116 using, for example, wire bonding. EPIC die stacks 114 may be used to, for example, generate, manipulate, and/or detect qubits (e.g., photonic qubits that employ one or more photons) or entangled states of qubits for optical quantum computing.

As described above, a qubit may be physically realized using a pair of waveguides into which a single photon is introduced. Qubits can be operated upon using mode couplers (e.g., beam splitters), variable phase shifters, photon detectors, and the like. For instance, entanglement between two (or more) qubits can be created by providing mode couplers between waveguides associated with different qubits. Physical qubits may suffer from loss and noise. Consequently, relying on single physical qubits (e.g., a photon propagating in a pair of waveguides) when performing a quantum computation may result in an unacceptably high error rate. To provide fault tolerance, photonic quantum computers can be designed to operate on one or more logical qubits, where a logical qubit is a multi-qubit quantum system in an entangled state that enables error correction (also referred to herein as an error correcting code). For example, in some embodiments, the structure of the error correcting code can be represented as a graph in three dimensions. In the context of quantum computing, logical qubits can improve robustness by supporting error detection and error correction. Logical qubits may also be used in other contexts, such as quantum communication.

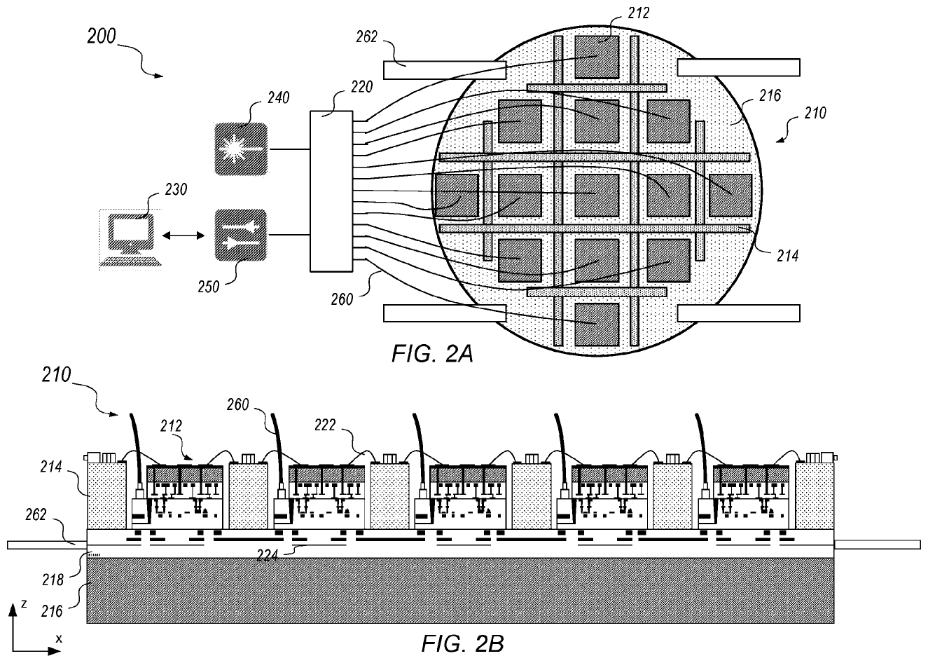

FIG. 2A illustrates an example of a subsystem 200 for generating entangled quantum states (e.g., resource states or logical qubits) according to certain embodiments. Subsystem 200 may include a wafer-scale module 210 that includes multiple EPIC die stacks 212 bonded to an optical backplane 216. Wafer-scale module 210 may be an example of wafer-scale module 110. EPIC die stacks 212 may be manufactured and then bonded to optical backplane 216. For example, a manufactured and tested PIC wafer and a manufactured and tested EIC wafer may be aligned and bonded through wafer-to-wafer fusion or hybrid bonding to form a wafer stack, and the wafer stack may be diced to singulate the EPIC die stacks.

Wafer-scale module 210 may also include a plurality of PCBs 214 (e.g., an electrical backplane). The EIC dies in EPIC die stacks 212 may be electrically connected to PCBs 214 using, for example, wire bonding. EPIC die stacks 212 may be used to, for example, generate, manipulate, and detect qubits or entangled states of qubits for optical quantum computing or optical quantum communication. For example, EPIC die stacks 212 may include single photon generators, mode couplers, fusion gates, beam splitters, switches, single photon detectors or multi-photon detectors, waveguides, delay lines, modulators, optical switches, ring oscillators, couplers, photodiode-based photodetectors for receiving data and timing signals, and the like. EPIC die stacks 212 may be optically connected together through optical fibers, optical waveguides in optical backplane 216, free-space optical interconnects, and/or other optical interconnects.

Wafer-scale module 210 may be connected to a distribution network 220 through optical fibers 260. Optical fibers 260 may be coupled to EPIC die stacks 212 through, for example, grating couplers, edge couplers, and/or optical backplane 216. Distribution network 220 may be connected to one or more pump laser sources 240 and a control unit 230 (e.g., through an optical transceiver 250). Control unit 230 may include, for example, a classical computing system. In some embodiments, control unit 230 and/or distribution network 220 may be used to control two or more wafer-scale modules 210. Optical fibers 260 may be used to, for example, send pump laser pulses from pump laser sources 240 to EPIC die stacks 212 for single photon generation, send control data from control unit 230 and optical transceiver 250 to EPIC die stacks 212 (e.g., to control switches), send measurement data from EPIC die stacks 212 to optical transceiver 250 and control unit 230, and the like.

In one example, an EPIC die stack 212 may include a single photon generator that includes waveguides, ring oscillators, interferometers, couplers, optical switches, WDM filters, single photon detectors, and the like that form multiple multiplexed photon pair sources to deterministically generate single photons through a nonlinear optical process (e.g., spontaneous parametric down conversion (SPDC), spontaneous four wave mixing (SFWM), second harmonic generation, etc.). In one embodiment, each photon pair source may include a micro-ring-based SFWM heralded photon source (HPS), where the detection of one photon of a pair of photons (generated by the nonlinear process) by a single photon detector (e.g., a superconductive nanowire single photon detector (SNSPD)) may herald the existence of the other photon in the pair that may be used to implement a qubit or generate an entangled resource state. Other types of photon sources that do not use a nonlinear material may also be employed, such as those that employ atomic and/or artificial atomic systems (e.g., quantum dot sources, color centers in crystals, etc.). The operations of some photon sources may be non-deterministic (also sometimes referred to as “stochastic”) such that a given pump pulse may or may not produce a pair of photons. In such photon sources, coherent spatial and/or temporal multiplexing of several non-deterministic photon sources may be performed to increase the probability of having one photon in any given cycle. When the number of multiplexed non-deterministic photon sources is large, the probability of having one photon in any given cycle may be about 100%.

As illustrated in FIG. 2A, wafer-scale module 210 may be coupled to one or more optical fibers 262. The one or more optical fibers 262 may be used to transmit single photons, qubits, or entangled states of qubits between different wafer-scale modules 210 or may be used to loop qubits back to the same wafer-scale module after a delay. As described above and below, in some embodiments, optical fibers 262 may be coupled to waveguides in optical backplane 216 through low-loss couplers. In some embodiments, optical fibers 262 may be used as a long delay line for delaying the qubits to perform time-like resource state fusion operations as described in details below. In some embodiments, optical fibers 262 may also be used for data communication or for transmitting pump laser pulses.

FIG. 2B is a cross-sectional view of the example of wafer-scale module 210 according to certain embodiments. As shown in FIGS. 2A and 2B, wafer-scale module 210 may include multiple EPIC die stacks 212, multiple PCBs 214, and optical fiber bundles. EPIC die stacks 212 may be optically connected to each other or other wafer-scale modules through an optical backplane 216, and may be electrically connected to PCBs 214 through bonding wires 222. Optical backplane 216 may include a dielectric layer 218 that includes one or more waveguide layers formed therein. The one or more waveguide layers may include low-loss waveguides 224 for transmitting, delaying, or storing single photons, qubits, qudits, resource states, or other entangled states. For example, waveguides 224 may include pairs of waveguides used to implement or transmit qubits and/or entangled qubits (e.g., resource states or larger entangled states of qubits). Photons may be coupled from one waveguide to another waveguide or from one waveguide layer to another waveguide layer through, for example, waveguide couplers. Photons may also be coupled from waveguides 224 in optical backplane 216 to waveguides in EPIC die stacks 212 through other waveguide layers and waveguide couplers in optical backplane 216 and/or EPIC die stacks 212. The waveguide couplers can be any type of waveguide coupler, e.g., adiabatic and/or evanescent waveguide couplers.

In the illustrated example, each EPIC die stack 212 may include a grating coupler as described above with respect to, for example, FIG. 2A, for receiving pump light and/or data communication signals from an optical fiber 260. Optical fibers 262 may be coupled to waveguides 224 in optical backplane 216 through optical input/output ports that may include, for example, V-groove alignment structures and low-loss couplers, such as a tapered structure, a subwavelength grating, an edge coupler, and the like. Optical fibers 262 may be connected to other wafer-scale modules 210 or may be connected to different portions of wafer-scale module 210 (e.g., loop photons or qubits from wafer-scale module 210 back to wafer-scale module 210 after a delay).

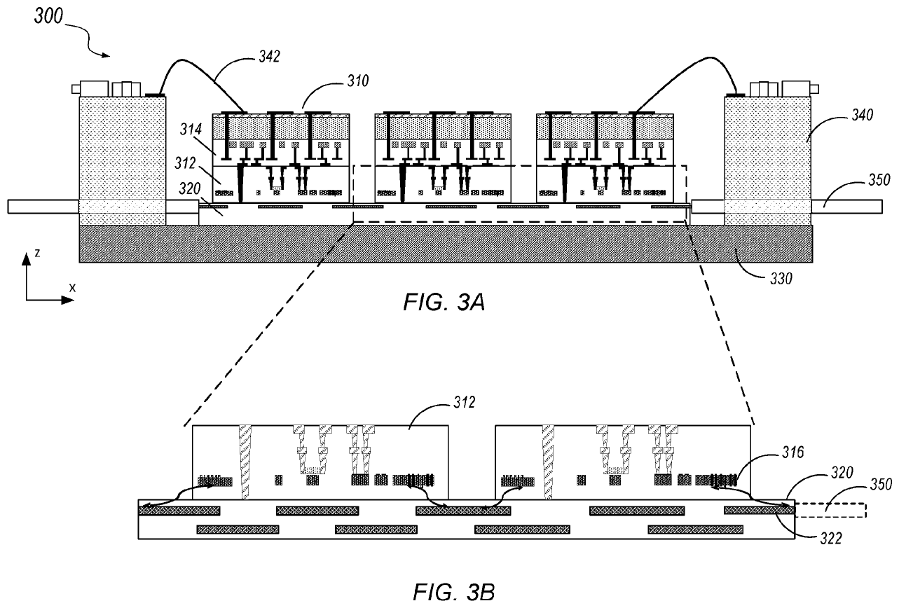

FIG. 3A is a cross-sectional view of an example of a wafer-scale module 300 including multiple EPIC die stacks 310 coupled to an optical backplane 320 according to certain embodiments. Wafer-scale module 300 may be an example of wafer-scale module 110 or 210. FIG. 3B is a zoom-in view of the example of wafer-scale module 300 according to certain embodiments. FIG. 3B shows the optical coupling between PIC dies 312 and optical backplane 320. Optical backplane 320 may be used as an optical interposer for bonding EPIC die stacks 310 to a substrate and for optically connecting EPIC die stacks 310.

Wafer-scale module 300 may be used in, for example, optical quantum computers, communication systems, and other electrical-optical hybrid systems. In the illustrated example, wafer-scale module 300 includes a handle wafer 330 (a silicon wafer) with optical backplane 320 formed or bonded thereon. Multiple EPIC die stacks 310 may be bonded to optical backplane 320, for example, through oxide-to-oxide bonding. Each EPIC die stack 310 includes an EIC die 314 and a PIC die 312 bonded together through bonding pads or bonding bumps on the EIC die and the PIC die such that the electrical interconnects between the EIC and the PIC can be short. Electrical backplane devices 340 (e.g., PCBs) may be bonded to handle wafer 330 or optical backplane 320. Electrical backplane devices 340 may be electrically connected to EPIC die stacks 310 through, for example, bonding wires 342. Optical fibers 350 may be coupled to optical backplane 320 through, for example, edge couplers, tapered structures, and/or alignment structures (e.g., V-grooves formed on handle wafer 330).

Wafer-scale module 300 may be used to, for example, generate single photons using a pump laser pulse, waveguides, optical switches, ring oscillators, couplers, wavelength-division multiplexing (WDM) beam splitter, single photon detectors (e.g., for detecting heralding photons), and the like, through a nonlinear process, such as spontaneous parametric down conversion (SPDC) or spontaneous four wave mixing (SFWM). In some embodiments, coherent spatial and/or temporal multiplexing of several non-deterministic photon sources may be performed to increase the probability of generating one photon in a given cycle. Wafer-scale module 300 may also be used to generate resource states or other entangled states of qubits from the single photons using, for example, waveguides, delay lines, couplers, splitters, switches, modulators, fusion gates, and the like.

Wafer-scale module 300 may also be used to detect photons or qubits using, for example, single photon detectors, waveguides, delay lines, and the like. Single photon detectors, such as superconductive nanowire single photon detectors (SNSPDs), may be used to detect a herald photon that signals the generation of a single photon in a single photon generator, or may be used to detect single photons within entangled states (e.g., resource states) in order to detect or perform logical operations on logical quits. In some embodiments, wafer-scale module 300 may include optical isolation structures for scattering mitigation, such that stray light scattered by other circuits in wafer-scale module 300 may not reach the single photon detectors. For example, PIC die 312 may include opaque structures surrounding the single photon detectors to prevent stray light from reaching the single photon detectors. The single photon detectors may also need to operate at very low temperature, such as cryogenic temperatures. Thus, wafer-scale module 300 may also include cooling structures and thermal isolation structures such that heat generated in other regions would not reach regions that need to operate at low temperatures (e.g., cryogenic temperatures). For example, PIC die 312 may include cooling structures, such as metal conductors or microfluidic channels. In some embodiments, PIC die 312 may also include heating elements. In some embodiments, PIC die 312 may also include thermal isolation structures to isolate photonic circuits that may need to operate at low temperatures or to prevent heat loss of heating elements.

In some embodiments, wafer-scale module 300 may include photodetectors or optical transceivers to receive and/or transmit optical communication signals, such as data and timing signals. In one example, wafer-scale module 300 may include Ge photodiode-based photodetectors for receiving data and timing signals from a control unit. In another example, PIC die 312 and EIC die 314 may include optical transceivers for communicating with, for example, a control unit. In some embodiments, PIC die 312 and EIC die 314 may include optical modulators.

FIG. 3B shows the optical coupling between PIC dies 312 and optical backplane 320. Optical backplane 320 may include one or more waveguide layers that include multiple waveguides 322. In some embodiments, one waveguide layer may include routing waveguides for optically connecting PIC dies 312 and another waveguide layer may include delay lines. Light from an optical fiber 350 or a PIC die 312 may be coupled into a waveguide 322. The light may propagate in waveguide 322 and may be coupled into PIC dies 312 by a waveguide coupler 316. In some embodiments, the light signals may also be coupled into waveguides in different waveguide layers in optical backplane 320. In some embodiments, light may also be coupled from a PIC die 312 to a waveguide 322 in optical backplane 320 by a waveguide coupler 316, and may then be coupled from waveguide 322 to another PIC die 312 by another waveguide coupler 316. Thus, waveguides 322 may be used for light signal routing, layer-to-layer transition, and the like.

It can be very challenging to integrate circuits and components into a system as described above with respect to FIGS. 1A-3B to achieve the desired functions and performance. For example, the optical couplers and interconnects between these circuits and components may be very lossy. In a system that may include many of these optical couplers and interconnects on a same signal path, the total loss caused by these optical couplers and interconnects may be high. Thus, it can be very difficult to use such a system to reliably manipulate and transport optical signals for optical quantum computing or communication where single photons or entangled photons need to be generated, manipulated, transported, and detected.

According to certain embodiments, an optical interposer (also referred to as an optical backplane) including multi-layer coupled waveguides may be used to optically couple die stacks, provide low-loss optical delays, couple photons (qubit states) between photonic integrated circuits and optical fibers, and the like. In some embodiments, the multi-layer coupled waveguides may include a multi-layer waveguide structure with monotonically varying layer separations and waveguide thicknesses, where waveguides on adjacent layers may at least partially overlap for optical mode coupling. For example, the layer separation may gradually increase from the top waveguide layer to the bottom waveguide layer, while the thickness of the waveguide layers may gradually decrease from the top waveguide layer to the bottom waveguide layer. As such, thinner waveguides, the guided modes of which may have larger optical fields, may be on deeper waveguide layers, such that the optical fields of the guide modes may be within and confined by the oxide layer of the optical interposer, thereby reducing optical losses of the waveguides. The multi-layer waveguide structure may be used to couple light from a photonic integrated circuit bonded to the optical interposer to a low-loss, long delay line, to an edge coupled optical fiber, or to another photonic integrated circuit bonded to the optical interposer.

For example, light from a PIC may be coupled into an optical interposer, and may be further coupled layer to layer by the multi-layer coupled waveguide structure down to thinner and deeper waveguide layers. The optical modes guided by thinner waveguides may have larger optical fields that may better match the optical field of the guided mode of the optical fiber. Therefore, the coupling efficiencies between the waveguides and the optical fiber, and thus the coupling efficiency between a PIC and the optical fiber, can be high.

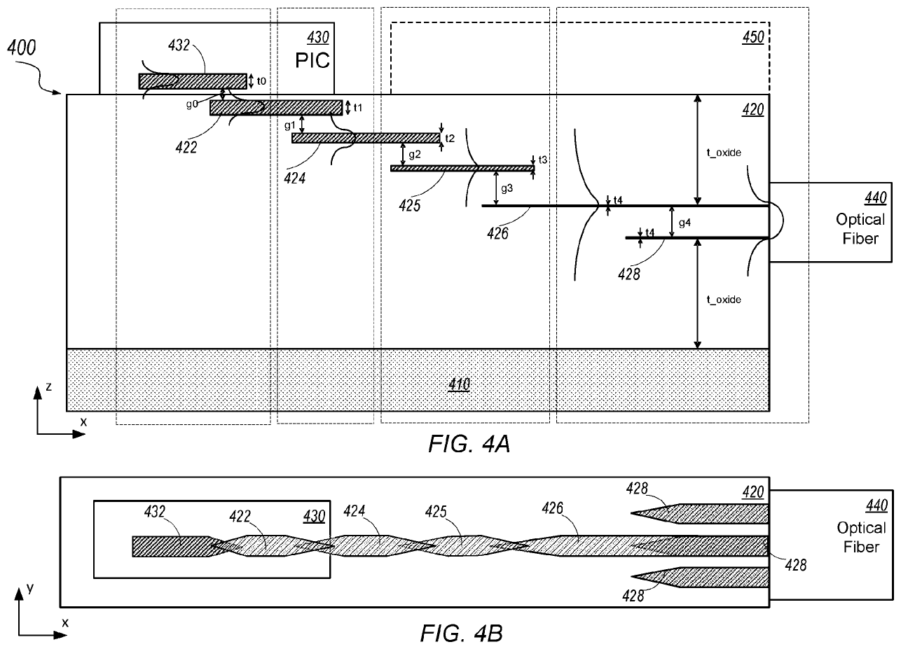

FIG. 4A is a cross-sectional view of an example of a multi-layer waveguide structure in an optical interposer 400 for coupling light between a photonic integrated circuit 430 and an optical fiber 440 according to certain embodiments. FIG. 4B is a top view of the example of the multi-layer waveguide structure of FIG. 4A. Optical interposer 400 may include a substrate 410 (e.g., a silicon wafer) and a plurality of waveguides formed in an oxide layer 420 (e.g., SiO₂). PIC 430 may include a waveguide 432 within an oxide material layer, and may be bonded to optical interposer 400, for example, through oxide-oxide thermocompression direct bonding, low-temperature oxide-oxide direct bonding, and the like. The waveguides in optical interposer 400 and PIC 430 may include a low-loss, high refractive index material, such as SiN. An optical fiber 440 may be coupled to optical interposer 400 at an edge of optical interposer 400.

In the illustrated example, optical interposer 400 may include multiple waveguide layers that couple photons between PIC 430 and optical fiber 440. For example, optical interposer 400 may include a first waveguide 422 in the top waveguide layer of optical interposer 400 and adjacent to waveguide 432 of PIC 430. The thickness of waveguide 432 may be t₀, and the thickness of first waveguide 422 may be t₁. First waveguide 422 and waveguide 432 may be close to each other (e.g., with a distance go between them), and may at least partially overlap (and thus having a certain coupling length) as shown in FIG. 4B, where the overlapped portions may be tapered in an x-y plane, such that the optical field of a guided mode in waveguide 432 may be gradually coupled into first waveguide 422 as shown in FIG. 4A, to accomplish PIC-to-interposer coupling.

A second waveguide 424 in optical interposer 400 may have a thickness t₂, and may be at a distance g₁ below first waveguide 422 in the z direction. Second waveguide 424 may be, for example, a routing waveguide for routing optical signals to various regions of optical interposer 400. Second waveguide 424 may at least partially overlap with first waveguide 422 as shown in FIGS. 4A and 4B, where the overlapped portions may be tapered, such that the optical field of the optical mode in first waveguide 422 may be gradually coupled into second waveguide 424, and may be routed to other regions of optical interposer 400.

A third waveguide 425 in optical interposer 400 may have a thickness t₃, and may be at a distance g₂ below second waveguide 424 in the z direction. Third waveguide 425 may be another outing waveguide or may be a delay line. Third waveguide 425 may at least partially overlap with second waveguide 424, where the overlapped portions may be tapered, such that the optical field of the optical mode in second waveguide 424 may be gradually coupled into third waveguide 425.

A fourth waveguide 426 in optical interposer 400 may have a thickness t₄, and may be at a distance g₃ below third waveguide 425 in the z direction. Fourth waveguide 426 may be, for example, a low-loss delay line. Fourth waveguide 426 may at least partially overlap with third waveguide 425, where the overlapped portions may be tapered, such that the optical field of the optical mode in third waveguide 425 may be gradually coupled into fourth waveguide 426. In some embodiments, there may be an array of coupled fourth waveguides 426 in a same waveguide layer, where the optical field in one fourth waveguide 426 may be laterally coupled into other fourth waveguides 426.

One or more fifth waveguides 428 in optical interposer 400 may have a thickness t₄, and may be at a distance g₄ below fourth waveguide 426 in the z direction. Fifth waveguides 428 may include an array of waveguides and may be used for edge coupling. The optical field of the optical mode in fourth waveguide(s) 426 may be at least partially coupled into fifth waveguides 428. Fifth waveguides 428 and fourth waveguide(s) 426 may at about the same distance t_{-oxide} from the bottom surface and the top surface of oxide layer 420, respectively.

In the example shown in FIGS. 4A and 4B, distance g₄ may be lower than, similar to, or greater than distance g₃, distance g₃ may be greater than distance g₂, distance g₂ may be greater than distance g₁, and distance g₁ may be greater than distance gₒ. Thickness to of waveguide 432 may be similar to or greater than thickness t₁ of first waveguide 422, and thus that the optical field of the optical mode of first waveguide 422 may be similar to or larger than the optical field of the optical mode of waveguide 432. Thickness t₂ of second waveguide 424 may be lower than thickness t₁ of first waveguide 422, and thus the optical field of the optical mode of second waveguide 424 may be larger than the optical field of the optical mode of first waveguide 422. Thickness t₃ of third waveguide 425 may be lower than thickness t₂ of second waveguide 424, and thus the optical field of the optical mode of third waveguide 425 may be larger than the optical field of the optical mode of second waveguide 424. Thickness t₄ of fourth waveguide 426 may be lower than thickness t₃ of third waveguide 425, and thus the optical field of the optical mode of fourth waveguide 426 may be larger than the optical field of the optical mode of third waveguide 425. Fourth waveguide(s) 426 and fifth waveguides 428 may have similar thicknesses and similar optical fields. The combined optical field of the optical modes in fourth waveguide(s) 426 and fifth waveguides 428 may approximately match the optical field of the guided optical mode of optical fiber 440, and thus light may be efficiently coupled between optical fiber 440 and fourth waveguide(s) 426 and fifth waveguides 428.

In one example, the waveguides in optical interposer 400 and PIC 430 include SiN waveguides, to may be about 400 nm, go may be about 300 nm, t₁ may be about 400 nm, g₁ may be about 500 nm, t₂ may be about 200 nm, g₂ may be about 2 μm, t₃ may be about 100 nm, g₃ may be about 7 μm, t₄ may be about 50 nm, g₄ may be about 3 μm, and t_{_oxide} may be about 10 μm. The PIC-to-interposer coupling loss (e.g., from waveguide 432 to first waveguide 422) may be about 5 mdB or lower. The coupling loss from first waveguide 422 to second waveguide 424 may be about 5 mdB or lower. The loss in second waveguide 424 may be about 1 dB/m or lower. The coupling loss from second waveguide 424 to fourth waveguide 426 may be about 10 mdB or lower. Fourth waveguide 426 may have a loss about 0.1 mdB/m, and the coupling loss from fourth waveguide 426 to optical fiber 440 may be about 25 mdB or lower. As such, the total optical loss from PIC 430 to optical fiber 440 can be less than about 40 mdB, or less than about 60 mdB with long routing or delay waveguides.

In some embodiments, distances g₀, g₁, g₂, g₃, and g₄ may be reduced, and an oxide layer 450 may be bonded to oxide layer 420, where the optical field of the guide mode in at least one of waveguides 424, 425, 426, and 428 may extend into oxide layer 450, as described in more detail below.

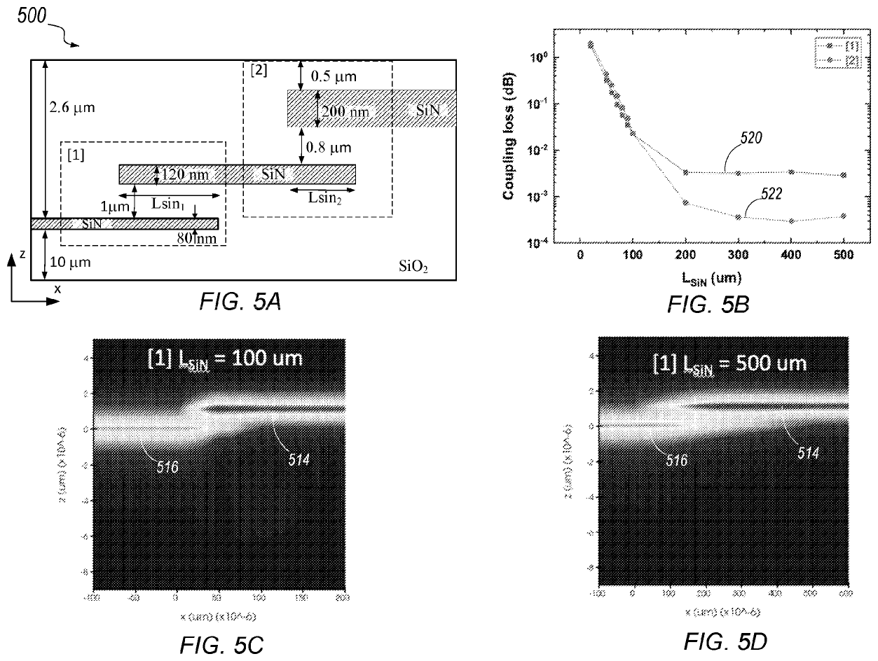

FIG. 5A is a cross-sectional view of an example of a multi-layer waveguide structure 500 in an optical interposer according to certain embodiments. In the illustrated example, multi-layer waveguide structure 500 may include an oxide layer 510, and a first waveguide 512, a second waveguide 514, and a third waveguide 516 within oxide layer 510. The waveguides may be SiN waveguides. First waveguide 512 may have a thickness about 200 nm and may be about 50 nm from the top surface of oxide layer 510. Second waveguide 514 may be about 0.8 um below first waveguide 512, and may have a thickness about 120 nm. Third waveguide 516 may be about 1 μm below second waveguide 514, and may have a thickness about 80 nm. Third waveguide 516 may be about 10 μm from the bottom surface of oxide layer 510. Third waveguide 516 and second waveguide 514 may be coupled at a first coupling zone with a coupling region (overlapped region) having a length L_{sin 1}, while second waveguide 514 and first waveguide 512 may be coupled at a second coupling zone with a coupling region (overlapped region) having a length L_{sin 2}.

FIG. 5B illustrates examples of coupling losses between waveguides in the multi-layer waveguide structure 500 as a function of the length of the coupling region (the overlapped region). A curve 520 in FIG. 5B shows the coupling loss as a function of the length L_{sin 1} of the coupling region at the first coupling zone. Curve 520 shows that the coupling loss may be less than 10 mdB when the length L_{sin 1} of the coupling region at the first coupling zone is about or greater than 200 μm. A curve 522 in FIG. 5B shows the coupling loss as a function of the length L_{sin 2} of the coupling region at the second coupling zone. Curve 522 shows that the coupling loss may be less than 1 mdB when the length L_{sin 2} of the coupling region at the second coupling zone is about or greater than 200 μm.

FIG. 5C includes a diagram illustrating an example of light coupling at the first coupling zone of FIG. 5A, where the length of the coupling region is about 100 μm. FIG. 5D includes a diagram illustrating an example of light coupling at the first coupling zone of FIG. 5A, where the length of the coupling region is about 500 μm.

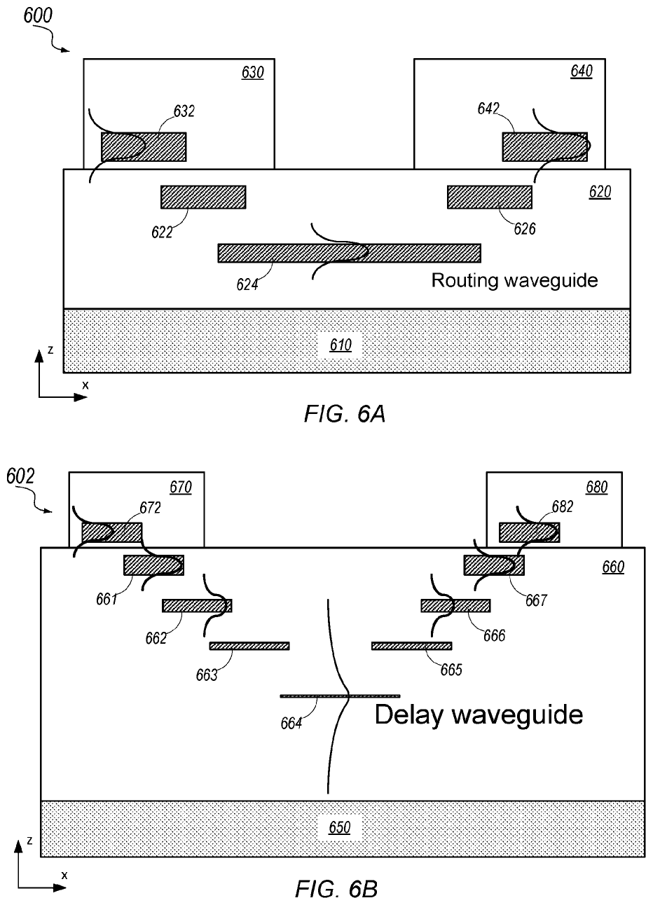

FIG. 6A illustrates an example of coupling light between two photonic integrated circuits using a multi-layer optical interposer according to certain embodiments. In the illustrated example, a device 600 may include an optical interposer that includes a substrate 610 (e.g., a silicon wafer) and multiple coupled waveguide layers formed in an oxide layer 620. A first PIC 630 and a second PIC 640 may be bonded to oxide layer 620 of the optical interposer through, for example, oxide-oxide bonding. First PIC 630 and second PIC 640 may be optically connected through the optical interposer.

As illustrated, the optical interposer may include at least two SiN waveguide layers having different thicknesses and at different depths within oxide layer 620. For example, the optical interposer may include a top waveguide layer that has a first thickness and includes two waveguides 622 and 626 for coupling with first PIC 630 and second PIC 640, respectively. The optical interposer may also include a second waveguide layer that includes a routing waveguide 624. Routing waveguide 624 may be sufficiency far from the top and bottom surfaces of oxide layer 620, such that routing waveguides 624 may have negligible additional loss. Routing waveguide 624 may be used to route photons to different regions of the optical interposer, and may also perform additional optical functionalities, such as beam splitter, filtering, polarization manipulation, and the like.

First PIC 630 may include a waveguide 632 (e.g., a SiN waveguide). Second PIC 640 may include a waveguide 642 (e.g., a SiN waveguide). Waveguide 632 and waveguide 642 may have high thicknesses such that the fields of the optical modes may be substantially confined within waveguide 632 and waveguide 642. The distance between waveguide 632 and waveguide 622 may be very small such that light propagating in waveguide 632 may be vertically coupled into waveguide 622. Light coupled into and propagating within waveguide 622 may be vertically coupled into routing waveguide 624 at the overlapped region between waveguide 622 and routing waveguide 624. Light coupled into routing waveguide may be transported by routing waveguide 624 to various regions of the optical interposer, such as a region of the optical interposer near second PIC 640, and may be vertically coupled into waveguide 626 at the overlapped region between waveguide 626 and routing waveguide 624. Light coupled into and propagating within waveguide 626 may be vertically coupled into waveguide 642 of second PIC 640 at the overlapped region between waveguide 642 and waveguide 626. As described above, the total coupling loss from first PIC 630 to second PIC 640 may be small, such as less than about 40 mdB or less than about 20 mdB.

FIG. 6B illustrates an example of delaying light transported between two photonic integrated circuits using a multi-layer optical interposer that includes a delay waveguide according to certain embodiments. In the illustrated example, a device 602 may include an optical interposer that includes a substrate 650 (e.g., a silicon wafer) and multiple waveguide layers formed in an oxide layer 660. A first PIC 670 and a second PIC 680 may be bonded to oxide layer 660 of the optical interposer through, for example, oxide-oxide bonding. First PIC 670 and second PIC 680 may be optically connected through the optical interposer.

As illustrated, the optical interposer may include multiple SiN waveguide layers having different thicknesses and at different depths within oxide layer 620. For example, the optical interposer may include a top waveguide layer that has a first thickness and includes waveguides 661 and 667 for coupling with first PIC 670 and second PIC 680, respectively. The optical interposer may also include a second waveguide layer that includes routing waveguides 662 and 666. A third waveguide layer in the optical interposer may include routing waveguides 663 and 665. A fourth waveguide layer in the optical interposer may include a delay waveguide 664. The thicknesses of the waveguide layers may gradually reduce as the depths of the waveguide layers in oxide layer 660 increase. The distances between adjacent waveguide layers may gradually increase as the depths of the waveguide layers in oxide layer 660 increase. As such, delay waveguide 664 in the fourth waveguide layer may be sufficiently far from both the top and bottom surfaces of oxide layer 660, such that additional losses of delay waveguide 664 may be negligible.

Light may be coupled from first PIC 670 into the delay waveguide and then coupled back into first PIC 670 or into second PIC 680, or may be coupled from second PIC 680 into the delay waveguide and then coupled back into second PIC 680 or into first PIC 670. In the illustrated example, light propagating in a waveguide 672 of first PIC 670 may be coupled into waveguide 661 of the optical interposer. The coupled light may be coupled into delay waveguide 664 through routing waveguides 662 and 663. Light may be delayed by delay waveguide 664 for a certain time delay, such as between about 10 ps and about 50 ns or longer. The delayed light may then be coupled into a waveguide 682 in second PIC 680 through, for example, waveguides 665, 666, and 667. As described above, the total coupling loss from first PIC 670 to second PIC 680 can be small, such as less than about 40 mdB, or less than about 60 mdB with long routing waveguides and/or delay waveguides.

As described above, to reduce the losses of waveguides with low thicknesses, which may have large optical fields, the waveguides within the optical interposer may need to be far away from the surfaces of the oxide layer of the optical interposer, such that the optical fields may be confined in the oxide layer. Therefore, the oxide layer of the optical interposer may need to have a high total thickness. In some embodiments, to reduce both the optical losses of the waveguides and the total thickness of the oxide layer of the optical interposer, additional waveguide devices (e.g., including an oxide layer and zero or more waveguide layers in the oxide layer) may be bonded to the optical interposer. The waveguide devices bonded to the optical interposer may include one or more waveguides, such as routing waveguides and/or delay waveguides. The waveguide layers in the optical interposer and waveguide devices can be close to the bonding surface. Even if the optical fields of the guided modes of the waveguides in the optical interposer or the waveguide device are large, the optical fields may extend into the waveguide device or the optical interposer, and thus may still be within and confined by the oxide material, thereby achieving a lower loss.

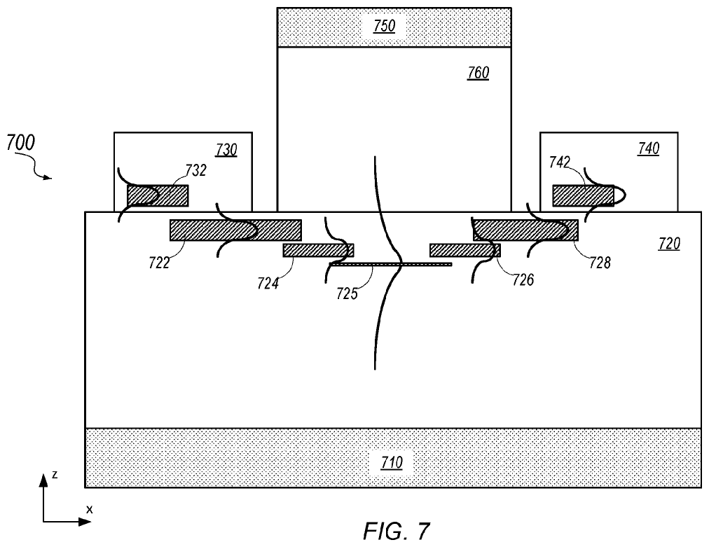

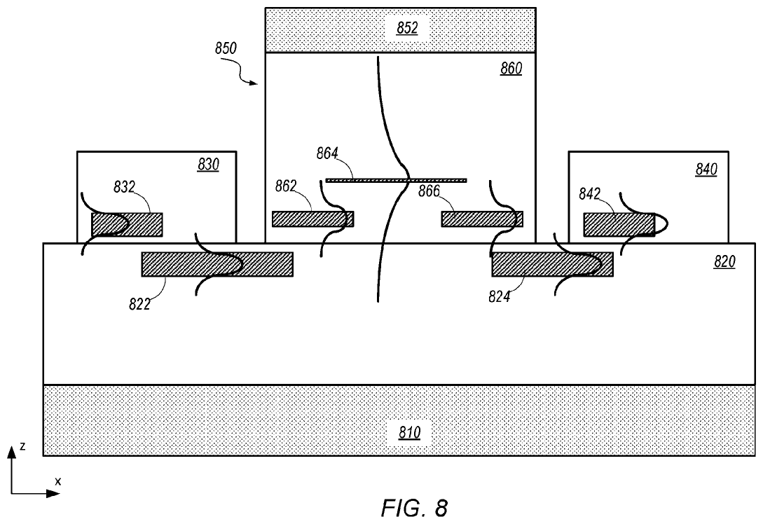

FIG. 7 illustrates an example of a device 700 including a multi-layer optical interposer with a shallow delay waveguide and an oxide layer bonded to the multi-layer optical interposer according to certain embodiments. In the illustrated example, the optical interposer may include a substrate 710 (e.g., a silicon wafer) and multiple waveguide layers formed in an oxide layer 720. A first PIC 730 and a second PIC 740 may be bonded to oxide layer 720 of the optical interposer through, for example, oxide-oxide bonding. First PIC 730 and second PIC 740 may be optically coupled through the optical interposer. A die including a substrate 750 (e.g., silicon substrate) and an oxide layer 760 may be bonded to oxide layer 720 of the optical interposer through, for example, oxide-oxide bonding.

As illustrated, the optical interposer may include multiple SiN waveguide layers having different thicknesses and at different depths within oxide layer 720. For example, the optical interposer may include a top waveguide layer that has a first thickness and includes waveguides 722 and 728 for coupling with first PIC 730 and second PIC 740, respectively. The optical interposer may also include a second waveguide layer that includes routing waveguides 724 and 726. A third waveguide layer in the optical interposer may include a delay waveguide 725 and may have a large distance from the bottom surface of oxide layer 720. The thicknesses of the waveguide layers may gradually reduce as the depths of the waveguide layers in oxide layer 720 increase. The distances between adjacent waveguide layers may be small and may gradually increase as the depths of the waveguide layers in oxide layer 720 increase. Therefore, delay waveguide 725 in the third waveguide layer may be at a large distance from the bottom surface of oxide layer 720, but may be at a short distance from the top surfaces of oxide layer 720. As such, the optical field of the guide mode in delay waveguide 725 may extend beyond the top surface of oxide layer 720 to cause additional losses if oxide layer 760 was absent. However, since oxide layer 760 may be on top of delay waveguide 725, the optical field of the guide mode in delay waveguide 725 may extend into oxide layer 760, and thus may still be confined within the oxide to achieve low losses, such as less than 0.1 mdB/m or lower.

Light may be coupled from first PIC 730 into the delay waveguide and then coupled back into first PIC 730 or into second PIC 740, or may be coupled from second PIC 740 into the delay waveguide and then coupled back into second PIC 740 or into first PIC 730. For example, light propagating in a waveguide 732 of first PIC 730 may be coupled into waveguide 722 of the optical interposer. The coupled light may be coupled into delay waveguide 725 through routing waveguide 724. Light may be delayed by delay waveguide 725 for a certain time delay, such as between about 10 ps and about 50 ns or longer. The delayed light may then be coupled into a waveguide 742 in second PIC 740 through, for example, waveguides 726 and 728.

FIG. 8 illustrates an example of delaying light transported between two photonic integrated circuits using an optical interposer and a waveguide device bonded to the optical interposer according to certain embodiments. In the illustrated example, the optical interposer may include a substrate 810 (e.g., a silicon wafer) and multiple waveguide layers formed in an oxide layer 820. A first PIC 830 and a second PIC 840 may be bonded to oxide layer 820 of the optical interposer through, for example, oxide-oxide bonding. First PIC 830 and second PIC 840 may be optically connected through the optical interposer and a waveguide device 850 (e.g., a passive PIC) bonded to the optical interposer. Light may be coupled from first PIC 830 into a delay waveguide in waveguide device 850 through the optical interposer, and then coupled back into first PIC 830 or into second PIC 840 through the optical interposer. Waveguide device 850 may include a substrate 852 (e.g., silicon substrate) and an oxide layer 860 bonded to oxide layer 820 of the optical interposer through, for example, oxide-oxide bonding. One or more waveguide layers may be formed in oxide layer 860.

In the example illustrated in FIG. 8, the optical interposer may include a waveguide layer that includes waveguides 822 and 824. Waveguides 822 and 824 may be used to couple with a waveguide 832 in first PIC 830 and a waveguide 842 in second PIC 840, respectively. Waveguide device 850 may include multiple SiN waveguide layers having different thicknesses and at different depths within oxide layer 860. For example, waveguide device 850 may include a first waveguide layer that includes routing waveguides 862 and 866, and a second waveguide layer that includes a delay waveguide 864. Delay waveguide 864 may have a large distance from the bottom surface of oxide layer 860 (the interface between oxide layer 860 and substrate 852). Delay waveguide 864 may have a lower thickness than waveguides 862 and 866, and thus the optical mode guided by delay waveguide 864 may have a large optical field. The optical field of the optical mode guided by delay waveguide 864 may extend into oxide layer 820 of the optical interposer, and thus may still be confined within the oxide material to achieve a low loss.

In the illustrated example, light may be coupled from first PIC 830 into waveguide 822 in the optical interposer. Light coupled into waveguide 822 may be coupled into waveguide 862 in waveguide device 850, and may then be coupled into delay waveguide 864. Light delayed by delay waveguide 864 (e.g., by a time delay between about 10 ps and about 50 ns or longer) may be coupled into waveguide 866, and then coupled into waveguide 824 in the optical interposer. Light coupled into and propagating within waveguide 824 may be coupled into waveguide 842 in second PIC 840.

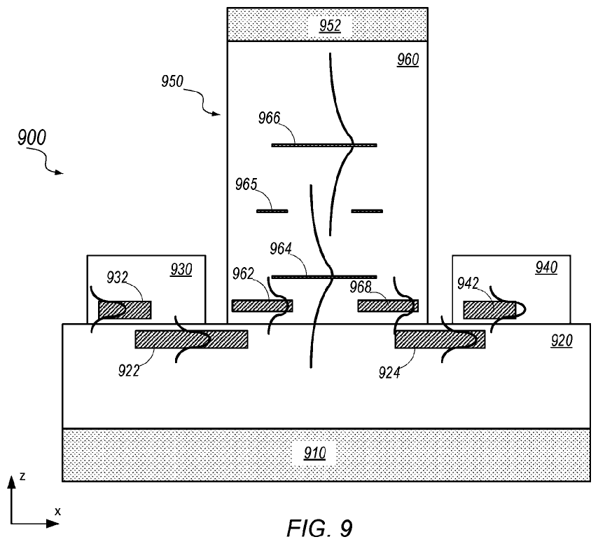

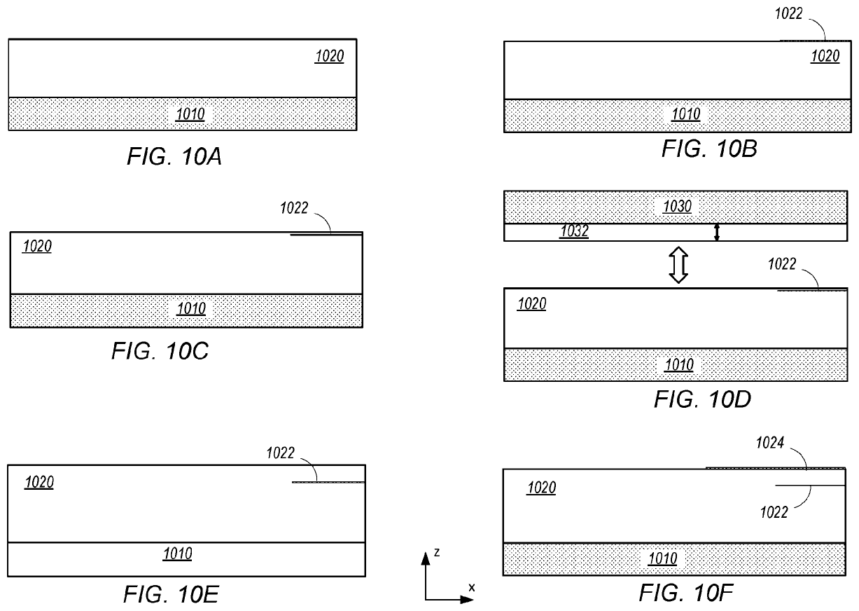

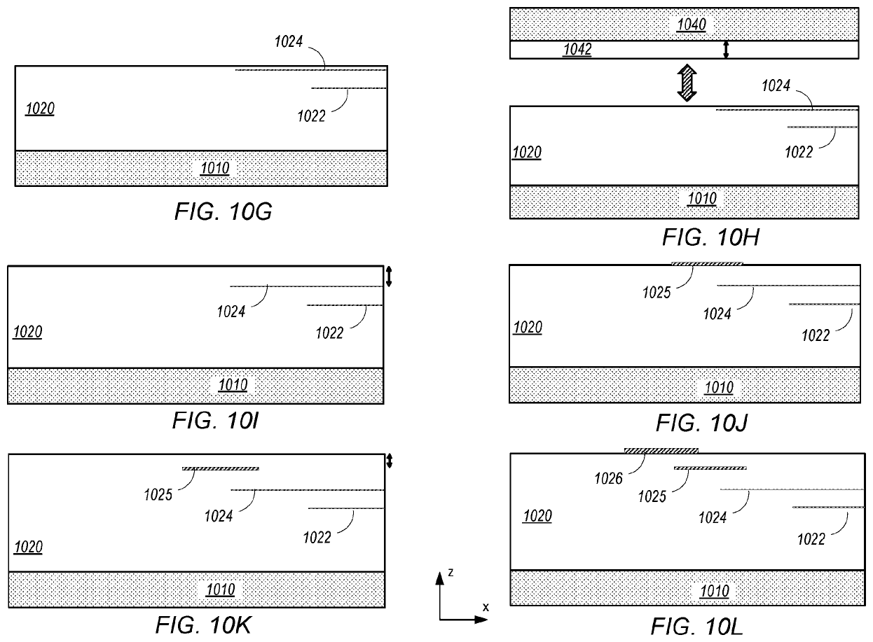

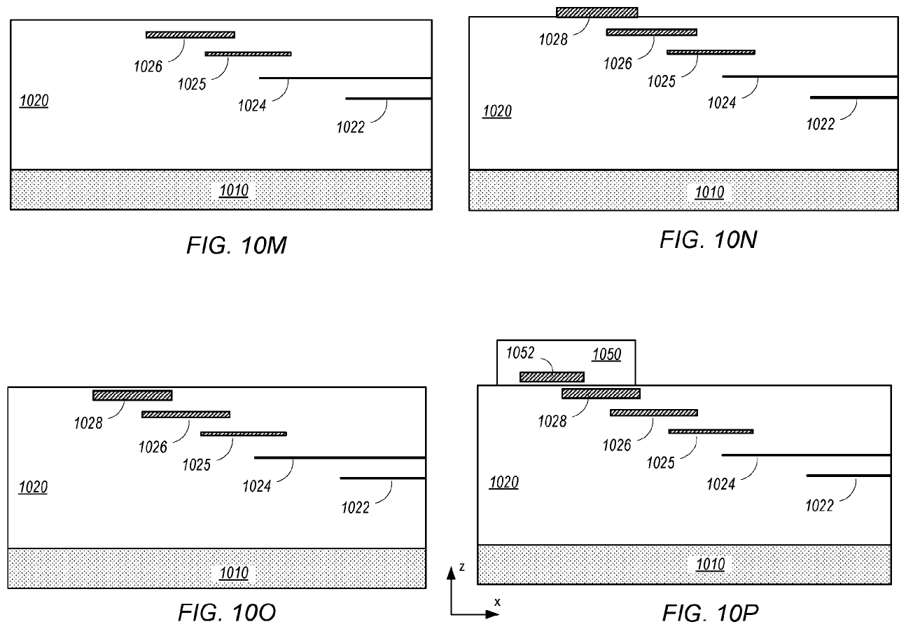

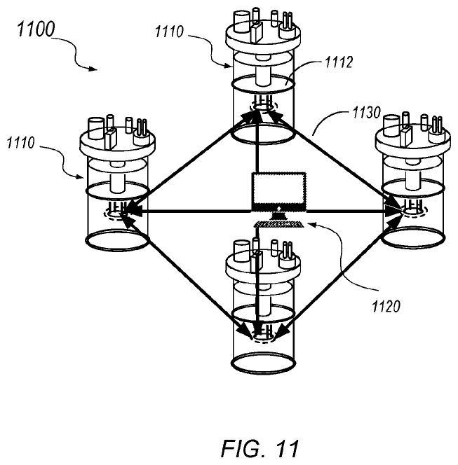

FIG. 9 illustrates an example of a device 900 including an optical interposer and a waveguide device (e.g., a passive or active PIC) bonded to the optical interposer for transporting and/or delaying light between photonic integrated circuits according to certain embodiments. In the illustrated example, the optical interposer may include a substrate 910 (e.g., a silicon wafer) and multiple waveguide layers formed in an oxide layer 920. A first PIC 930 and a second PIC 940 may be bonded to oxide layer 920 of the optical interposer through, for example, oxide-oxide bonding. First PIC 930 and second PIC 940 may be optically coupled through the optical interposer and a waveguide device 950 bonded to the optical interposer. Light may be coupled from first PIC 930 into one or more delay waveguides in waveguide device 950 through the optical interposer, and then coupled back into first PIC 930 or into second PIC 940 through the optical interposer. Waveguide device 950 may include a substrate 952 (e.g., silicon substrate) and an oxide layer 960 bonded to oxide layer 920 of the optical interposer through, for example, oxide-oxide bonding. Waveguide device 950 may include multiple waveguide layers formed in oxide layer 960.

In the example illustrated in FIG. 9, the optical interposer may include a waveguide layer that includes waveguides 922 and 924. Waveguides 922 and 924 may be used to couple with a waveguide 932 in first PIC 930 and a waveguide 942 in second PIC 940, respectively. Waveguide device 950 may include multiple SiN waveguide layers having different thicknesses and at different depths within oxide layer 960. For example, waveguide device 950 may include a first waveguide layer that includes routing waveguides 962 and 968, and multiple delay waveguide layers that include delay waveguides 964, 965, 966, and the like. Light may be coupled between delay waveguides 964, 965, 966, and the like, to achieve a long time delay. Delay waveguides 964, 965, and 966 may have lower thicknesses than waveguides 962 and 966, and thus the optical modes guided by delay waveguides 964, 965, and 966 may have large optical fields. Delay waveguide 964 may have a large distance from the bottom surface of oxide layer 960 (the interface between oxide layer 960 and substrate 952). The optical field of the optical mode guided by delay waveguide 964 may extend into oxide layer 920 of the optical interposer, and thus may be confined within the oxide material to achieve a low loss. In some embodiments, the optical fields of the optical modes guided by delay waveguide 965 and/or delay waveguide 966 may also extend into oxide layer 920 of the optical interposer to achieve a low loss. In some embodiments, delay waveguides 965 and 966 in oxide layer 960 may be sufficiently far away from both the top and bottom surfaces of oxide layer 960, such that additional losses of delay waveguides 965 and 966 may be negligible.

FIGS. 10A-10P illustrate an example of a process of fabricating an optical interposer including a multi-layer waveguide structure for coupling light between a photonic integrated circuit and an optical fiber according to certain embodiments. It should be appreciated that the specific operations illustrated in FIGS. 10A-10P provide a particular method of fabricating an optical interposer, such as the optical interposers shown in FIGS. 4A, 4B, 6A, 6B, and 7, according to another embodiment. Other sequences of operations may also be performed according to alternative embodiments. For example, the alternative embodiments may perform the operations outlined above in a different order. Moreover, the individual operations illustrated in FIGS. 10A-10P may include multiple sub-operations that may be performed in various sequences as appropriate to the individual step. Furthermore, additional operations may be added or removed depending on the particular applications. One of ordinary skill in the art would recognize many variations, modifications, and alternatives.

FIG. 10A shows an example of a first wafer including a substrate 1010 and an oxide layer 1020 formed on substrate 1010. Substrate 1010 may include, for example, a silicon wafer. Oxide layer 1020 may be formed on substrate 1010 by deposition or oxidation of substrate 1010. The thickness of oxide layer 1020 may be, for example, about 10 μm or higher.

FIG. 10B shows a waveguide 1022 formed on oxide layer 1020. Waveguide 1022 may include, for example, SiN, and may be formed by depositing a SiN layer on oxide layer 1020 and patterning the SiN layer using a photolithography process. Waveguide 1022 may have a thickness about, for example, tens of nanometers or higher, such as about 50 nm.

FIG. 10C shows that a thin oxide layer may be deposited on oxide layer 1020 to cover waveguide 1022. The thin oxide layer may be deposited using any suitable chemical deposition techniques or physical deposition techniques. A planarization process, such as chemical mechanical polishing (CMP), may be performed to planarize the top surface of the oxide layer for subsequent processing. Oxide layer 1020 on substrate 1010 may have a higher thickness after the processing shown in FIG. 10C.

FIG. 10D shows that a second wafer including a substrate 1030 and a thin oxide layer 1032 may be bonded to the first wafer. Oxide layer 1032 may be a thermal oxide layer and may have a thickness less than about 10 μm, less than about 5 μm, less than about 3 μm, less than about 2 μm, or less than about 1 μm. In one example, oxide layer 1032 may have a thickness about 3 μm. Oxide layer 1032 may be bonded to oxide layer 1020 by, for example, oxide-to-oxide bonding described above.

FIG. 10E shows that substrate 1030 may be removed by, for example, etching, back grinding, or laser lifting, to expose oxide layer 1032. The oxide layer on substrate 1010 may have a higher total thickness after the bonding. For example, the oxide layer 1032 added on top of waveguide 1022 may have a thickness about 3 μm. In some embodiments, the top surface of the oxide layer on substrate 1010 may be planarized using, for example, CMP.

FIG. 10F shows a waveguide 1024 formed on the top surface of the oxide layer on substrate 1010. Waveguide 1024 may include, for example, SiN, and may be formed by depositing a SiN layer on the oxide layer and patterning the SiN layer using a photolithography process. Waveguide 1024 may have a thickness about, for example, tens of nanometers or hundreds of nanometers, such as about 50 nm. in some embodiments, waveguide 1024 may have a thickness similar to the thickness of waveguide 1022.

FIG. 10G shows that a thin oxide layer may be deposited on the oxide layer to cover waveguide 1024. The thin oxide layer may be deposited using any suitable chemical deposition techniques or physical deposition techniques. A planarization process, such as CMP, may be performed to planarize the top surface of the oxide layer.

FIG. 10H shows that a third wafer including a substrate 1040 and a thin oxide layer 1042 may be bonded to the first wafer. Oxide layer 1042 may be a thermal oxide layer and may have a thickness less than about 20 μm, less than about 10 μm, less than about 5 μm, less than about 2 μm, or less than about 1 μm. In one example, oxide layer 1042 may have a thickness about 7 μm. Oxide layer 1042 may be bonded to the oxide layer on substrate 1010 by, for example, oxide-to-oxide bonding described above.

FIG. 10I shows that substrate 1040 may be removed by, for example, etching, back grinding, or laser lifting, to expose oxide layer 1042. In some embodiments, the top surface of the oxide layer on substrate 1010 may be planarized using, for example, CMP. The oxide layer on top of waveguide 1024 may have a thickness, for example, about 7 μm.

FIG. 10J shows a waveguide 1025 formed on the top surface of the oxide layer on substrate 1010. Waveguide 1025 may include, for example, SiN, and may be formed by depositing a SiN layer on the oxide layer and patterning the SiN layer using a photolithography process. Waveguide 1025 may have a thickness about, for example, tens of nanometers or hundreds of nanometers, such as about 100 nm.

FIG. 10K shows that an oxide layer may be deposited on the first wafer to cover waveguide 1025. The oxide layer may be deposited using any suitable chemical deposition techniques or physical deposition techniques. The thickness of the oxide layer may be greater than about a few hundreds of nanometers or about 1 μm, such as about 2 μm. A planarization process, such as CMP, may be performed to planarize the top surface of the oxide layer.

FIG. 10L shows a waveguide 1026 formed on the top surface of the oxide layer on substrate 1010. Waveguide 1026 may include, for example, SiN, and may be formed by depositing a SiN layer on the oxide layer and patterning the SiN layer using a photolithography process. Waveguide 1026 may have a thickness about, for example, hundreds of nanometers, such as about 200 nm.

FIG. 10M shows that an oxide layer may be deposited on the first wafer to cover waveguide 1026. The oxide layer may be deposited using any suitable chemical deposition techniques or physical deposition techniques. The thickness of the oxide layer may be greater than about a few hundreds of nanometers to about a few microns, such as about 500 nm. A planarization process, such as CMP, may be performed to planarize the top surface of the oxide layer.

FIG. 10N shows a waveguide 1028 formed on the top surface of the oxide layer on substrate 1010. Waveguide 1028 may include, for example, SiN, and may be formed by depositing a SiN layer on the oxide layer and patterning the SiN layer using a photolithography process. Waveguide 1028 may have a thickness about, for example, hundreds of nanometers, such as about 300 or 400 nm.

FIG. 10O shows that a thin oxide layer may be deposited on the first wafer to cover waveguide 1028. The oxide layer may be deposited using any suitable chemical deposition techniques or physical deposition techniques. The thickness of the oxide layer may be between about a few tens of nanometers to about a few microns, such as about 200 nm. In some embodiments, a planarization process, such as CMP, may be performed to planarize the top surface of the oxide layer. An optical interposer, such as optical interposer 400, may be fabricated by the processing shown in FIGS. 10A-10O.

FIG. 10P also shows that a PIC 1050 including a waveguide 1052 may be bonded to the oxide layer on substrate 1010, for example, through oxide-to-oxide bonding, to form a wafer-level device as shown in, for example, FIGS. 2B-4B, 6A, and 6B. In some embodiments, an optical fiber may be positioned, for example, in a V-groove, and may be coupled to waveguides 1022 and 1024, as described above with respect to, for example, FIGS. 4A and 4B.

Waveguides in the optical interposers described above may have low losses, such as between about 0.03 dB/m and about 2 dB/m, between about 0.04 dB/m and about 1 dB/m, or between about 0.05 dB and about 0.5 dB/m. For example, in some embodiments, the waveguides may have a loss lower than about 1.0 dB/m, lower than about 0.5 dB/m, lower than about 0.4 dB/m, lower than 0.3 dB/m, or lower than 0.1 dB/m. In some embodiments, the waveguides may be made at high temperature and through long-time annealing to reduce the loss of the waveguides since the optical interposer may not include active photonic integrated circuits that may be degraded by high temperature processing. In some embodiments, the waveguides may include delay waveguides of various time delays, such as greater than about 10-100 ps, greater than about 1 ns, or greater than about 50 ns. In some embodiments, the waveguides may include pairs of waveguides for implementing and transporting qubits or entangled states of qubits. In some embodiments, the optical interposer may also include some other circuits or structures, such as dispersion compensators, polarization beam splitters/rotators, scattering mitigation structures, thermal management and local cooling structures, thermal isolation structures, and the like.

FIG. 11 illustrates an example of a system 1100 including multiple wafer-scale modules 1112 (e.g., wafer-scale module 110 or 210) coupled together through qubit interconnects 1130 and controlled by a control unit 1120 according to certain embodiments. System 1100 may be an example of a system for generating entangled states or error-corrected photonic logical qubits used in quantum computing or quantum communication, or may be an example of a quantum computing or quantum communication system. Wafer-scale modules 1112 may include, for example, one or more resource state generators, delay circuits, switch circuits, model couplers, fusion gates, photon detectors, and the like, as described above and below. Control unit 1120 may be a classical processing unit, such as a classical computer. Qubit interconnects 1130 between wafer-scale modules 1112 may be qubit interconnects implemented using, for example, optical fibers or free-space optical interconnects. The interconnect between control unit 1120 and each wafer-scale module 1112 may be a classical data communication channel that may include electrical cables or optical fibers for transmitting classical data signals, rather than qubits. At least some parts of wafer-scale modules 1112 may be in temperature-controlled chambers 1110 (e.g., a cryostat, a cryocooler, etc.). Temperature-controlled chambers 1110 may include different temperature chambers for different temperature ranges, such as cryogenic temperatures (e.g., about 4 K), low temperatures (e.g., about 50 K to about 100 K), and/or room temperatures. In some embodiments, more than one wafer-scale modules 1112 may be hosted by each temperature-controlled chamber 1110.

The wafer-scale modules described above may be used in an optical quantum computing system for generating, manipulating, and detecting qubits and entangled states of qubits. For example, each wafer-scale module described above may be used to generate one or more qubits, entangle the qubits to generate resource states, and/or perform resource state fusion operations. The wafer-scale modules may be used together to generate large, entangled states of qubits or logical qubits, perform quantum computing using the logical qubits, detect the logical qubits, and the like.

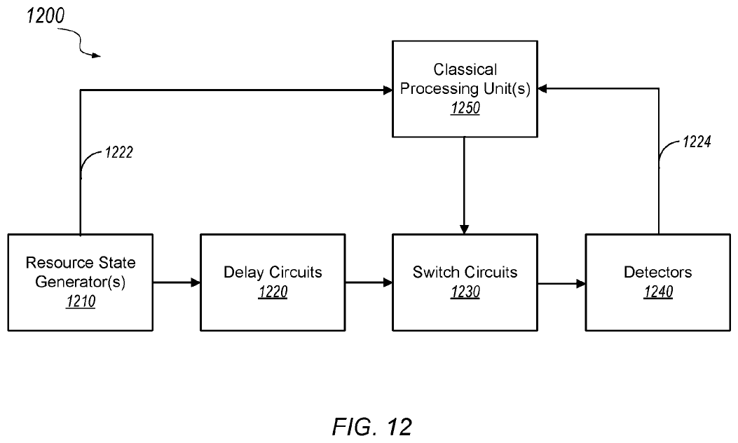

FIG. 12 is a simplified block diagram of an example of a quantum computing system 1200 according to some embodiments. Quantum computing system 1200 may implement, for example, measurement-based quantum computing (MBQC) or fusion-based quantum computing (FBQC). Some embodiments of quantum computing system 1200 may use photonic physical qubits to generate a fault-tolerant cluster state that can be used to represent logical qubits for MBQC, while other embodiments of quantum computing system 1200 may generate measurement data reflecting entanglement structures for fault-tolerant FBQC. In the illustrated example, quantum computing system 1200 may include resource state generator(s) 1210, delay circuits 1220, switch circuits 1230, detectors 1240, and one or more classical processing units 1250.

Resource state generators 1210 may include one or more resource state generators (RSGs). The RSGs may autonomously operate, with no data input needed. Each RSG may generate one resource state per clock cycle (which can be, e.g., shorter than about Ins, about 1 ns, or longer than about 1 ns). Each resource state may include multiple (e.g., 7 or 9) entangled physical qubits. The resource state can be output to delay circuits 1220 at a rate of, for example, about n*N photons per clock cycle, where n is the number of qubits in each resource state and N is the number of RSGs. Resource state generators 1210 can also send classical data output (e.g., indicating success or failure of various elements of the resource state generation process) to classical processing unit 1250 via a data path 1222. In some embodiments, resource state generators 1210 can be maintained at cryogenic temperatures (e.g., 4 K). Delay circuit 1220 can include optical fibers, other waveguides, optical memory, or other components to delay or store photons corresponding to particular qubits by appropriate delay times, such as 1 clock cycle, L clock cycles, and L² clock cycles, where L may be any integer number. Delay circuits 1220 may not need to operate at cryogenic temperatures. Photons exiting delay circuits 1220 can be delivered to switch circuits 1230 via, for example, optical fibers, on-chip waveguides, or any other type of waveguides or optical interconnects.

Switch circuits 1230 may include active switches and waveguides to perform mode coupling, mode swapping, phase shift, and other operations on the qubits. In various embodiments, switch circuits 1230 may perform mode coupling operations associated with fusion operations as described below and/or basis selection operations associated with measurement of individual qubits. In some embodiments, switch circuits 1230 may be dynamically reconfigurable in response to control signals from classical processing units 1250, and thus quantum computing system 1200 may perform different computations by reconfiguring switches in switch circuits 1230. Switch circuits 1230 may deliver output photons to detectors 1240 via, for example, optical fibers, on-chip waveguides, or any other type of optical interconnects.

Detectors 1240 may include photon detectors capable of detecting single or multiple photons. Each photon detector may be coupled to one waveguide and may generate an output (classical) signal indicating whether a photon was detected. In some embodiments, some or all detectors 1240 may be capable of counting photons, and the output signal from each detector 1240 may indicate the number of photons detected by the detector 1240. In some embodiments, detectors 1240 may operate at cryogenic temperatures. Detectors 1240 may provide classical output signals indicating the number of photons, or binary signals indicating whether a photon was detected, to classical processing unit 1250 via a signal path 1224, such as optical fibers.

Classical processing unit 1250 may be a classical computer system that is capable of communicating with resource state generator(s) 1210, switch circuits 1230, and detectors 1240 using classical digital logic signals. In some embodiments, classical processing unit 1250 may determine appropriate settings for switch circuits 1230 based on a particular quantum computation (or program) to be executed. Classical processing unit 1250 may receive feedback signals (e.g., measurement outcomes) from resource state generators 1210 and detectors 1240 and can determine the result of the computation based on the feedback signals. In some embodiments, classical processing unit 1250 can use feedback signals to modify subsequent control signals sent to switch circuits 1230. Operation of classical processing unit 1250 may incorporate error correction algorithms and other techniques.

Quantum computing system 1200 of FIG. 12 is illustrative, and variations and modifications are possible. Blocks shown separately can be combined, or a single block can be implemented using multiple distinct components. Resource state generator(s) 1210, delay circuits 1220, switch circuits 1230, and detectors 1240 can implement the circuits descried above and below for generating entanglement structures. For instance, delay circuits 1220 may implement delay lines for resource state fusion, while switch circuits 1230 may implement reconfigurable switches and mode couplers associated with reconfigurable fusion, and detectors 1240 may implement destructive measurements associated with fusion operations. Quantum computing system 1200 is just one example of a quantum computing system or another photonic system that can use the wafer-scale modules described herein. Those skilled in the art will appreciate that many different systems can be implemented using the wafer-scale modules that each include PIC or EPIC dies bonded to and optically coupled to an optical backplane having low-loss waveguides.

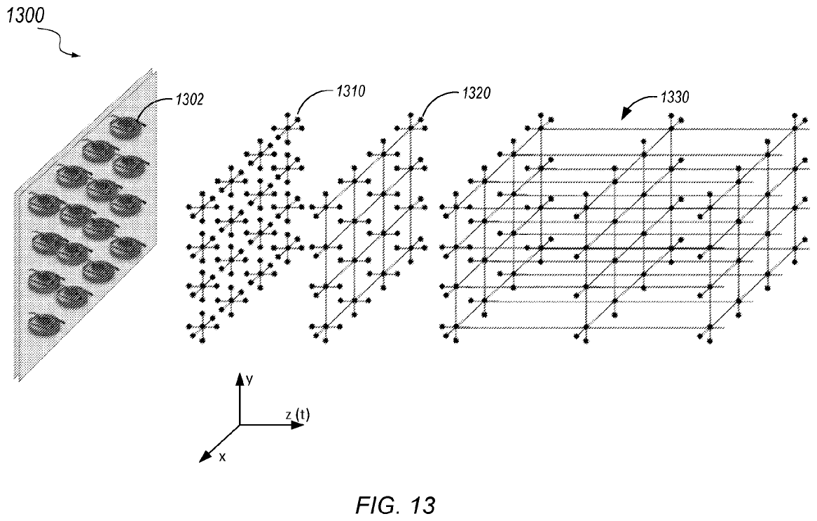

FIG. 13 illustrates an example of a system 1300 for generating large, entangled states (e.g., error-corrected photonic logical qubits) according to some embodiments. System 1300 may be an example of an MBQC system. System 1300 may include, for example, at least a portion of resource state generators 1210, delay circuits 1220, switch circuits 1230, and detectors 1240 described above. System 1300 may include a plurality of RSGs 1302. In some embodiments, each RSG 1302 may be implemented using a wafer-scale module described above. Each RSG 1302 may generate one resource state 1310 in each clock cycle as described above with respect to FIG. 13. In the illustrated example, each resource state 1310 may include seven entangled physical qubits. Resource states 1310 generated by RSGs 1302 in one clock cycle may form a large, entangled structure 1320 by space-like fusion operations in the x and y directions. Entangled structures 1320 formed in adjacent clock cycles may form a logical qubit 1330 by time-like fusion operations in the z direction (e.g., in the time domain). More detail of the space-like fusion operations and the time-like fusion operations is described below.

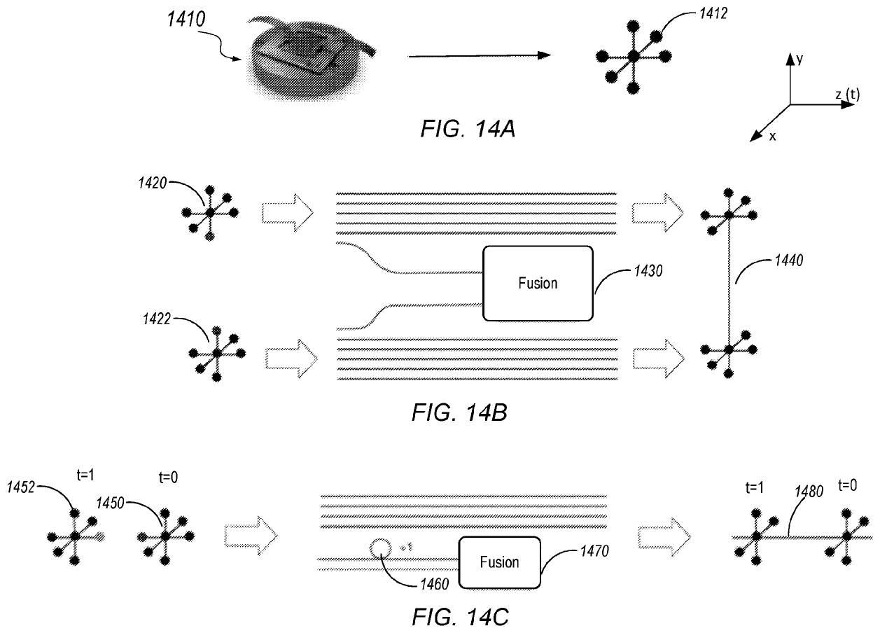

FIG. 14A illustrates an example of a resource state 1412 generated by a resource state generator 1410 according to some embodiments. In some embodiments, resource state generator 1410 may be implemented using a wafer-scale module described above. Resource state generator 1410 may include single photon sources and photonic integrated circuits for entangling the single photons. As described above, the single photon sources may each include, for instance, a resonator-based photon source that emits photon pairs, also referred to as a heralded single photon source. In one example, the photon source is driven by a pump (e.g., a laser light pulse) that is coupled into a system of optical resonators that may, through a nonlinear optical process (e.g., SFWM, SPDC, second harmonic generation, or the like), generate a pair of photons. One photon of the pair of photons may be detected by a single photon detector (e.g., an SNSPD). The detection of the photon may herald the existence of the other photon in the pair, which may then be used to generate entangled resource state. A qubit may be encoded by a single photon in a pair of modes (e.g., a dual-rail encoding), where each mode is a spatiotemporal mode that can be occupied by the photon and corresponds to the presence of a photon in a waveguide of a pair of waveguides. A photon source can be operated to emit a single photon into the waveguide to which it is coupled, thereby preparing a photonic qubit in a known state. By providing multiple pairs of waveguides, a quantum system having qubits whose logical states correspond to different spatiotemporal modes can be created. It should be understood that the waveguides in such a system need not have any particular spatial relationship to each other. For instance, they can be but need not be arranged in parallel.

RSG 1410 may also include mode couplers (e.g., 50:50 beam splitters or beam splitter networks) that may take a photon in any one of the input modes and delocalize the photon among each of the output modes such that the photon has equal probability of being detected in any one of the output modes. A waveguide beam splitter can be realized by bringing two waveguides into close proximity such that the evanescent field of one waveguide can couple into the other. By adjusting the separation between the two waveguides and/or the length of the coupling region, different couplings between modes can be obtained. In this manner, a waveguide beam splitter can be configured to have a desired transmissivity. For example, the beam splitter can be engineered to have a transmissivity equal to 0.5 (i.e., a 50/50 beam splitter). If other transfer matrices are desired, the reflectivity (or the transmissivity) can be engineered to be greater than 0.6, greater than 0.7, greater than 0.8, or greater than 0.9, without departing from the scope of the present disclosure. In some embodiments, entangled states of multiple photonic qubits may be created by coupling modes of two or more qubits and performing measurements on other modes. In some embodiments, cluster states of multiple entangled qubits may be formed through, for example, an entangling measurement, which is a projective measurement that can be employed to create entanglement between systems of qubits.

In the example shown in FIG. 14A, resource state 1412 may include seven entangled physical qubits, where each physical qubit may be represented by a dot and may be implemented by a pair of waveguides into which a photon may be introduced. The entanglement between physical qubits is represented by lines connecting pairs of dots. In the illustrated examples, the entanglement geometry may define a three-dimensional space, and labels x, y, and z are used to designate the different dimensions in this entanglement space. It should be understood that these dimensions need not correspond to physical dimensions and that, in some implementations, qubits may be separated in time rather than in spatial dimensions. For example, each physical qubit can be implemented using photons propagating in waveguides, and a particular section of waveguide may host photons associated with different qubits at different times.

FIG. 14B illustrates an example of a space-like resource state fusion operation according to some embodiments. FIG. 14B shows that a physical qubit from each of two resource states 1420 and 1422 arranged in the y direction may be passed to a fusion gate 1430. As described above, a fusion gate is a structure that receives two input qubits, each of which may be part of an entangled state. The fusion gate may perform a projective measurement operation on the input qubits that produces either one (“type I fusion”) or zero (“type II fusion”) output qubits in a manner such that the initial two entangled states are fused into a single entangled state. Fusion gates are specific examples of a general class of two-qubit entangling measurements and may be particularly suitable for photonic architectures. In the illustrated example, fusion gate 1430 may be a type II fusion gate, where no output qubit may be generated from the two input qubits. Thus, the resultant entangled structure 1440 may include 12 physical qubits.

FIG. 14C illustrates an example of a time-like resource state fusion operation according to some embodiments. FIG. 14C shows two resource states 1450 and 1452 generated in consecutive clock cycles. A physical qubit from resource state 1450 that is generated at a first clock cycle (t=0) may be delayed for a clock cycle by a delay line 1460, and may then be sent to a fusion gate 1470. A physical qubit in resource state 1452 that is generated at the next clock cycle (t=1) may also be passed to fusion gate 1470 to generate an entangled structure 1480. In the illustrated example, fusion gate 1470 may be a type II fusion gate, where no output qubit may be generated from the two input qubits.

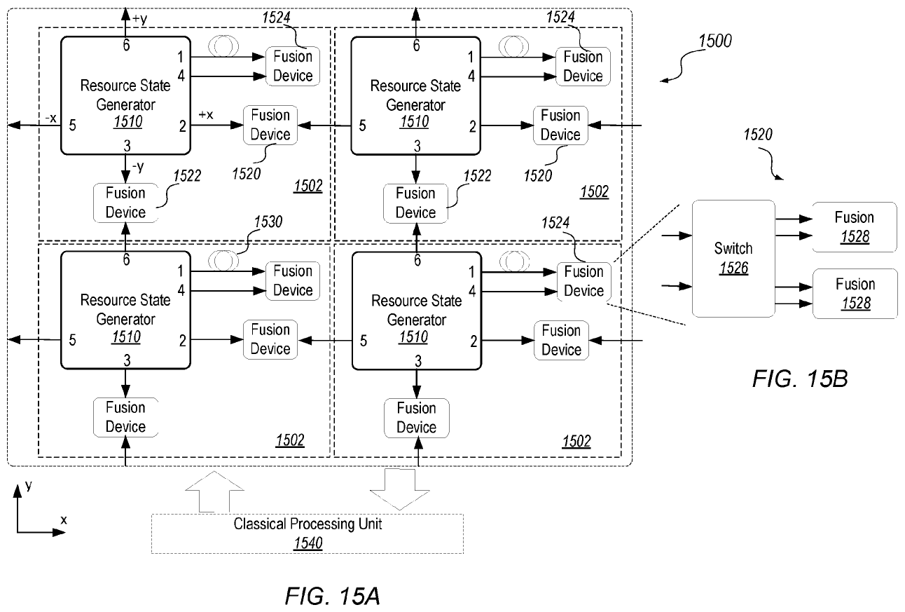

FIG. 15A illustrates a block diagram of an example of a network 1500 for generating entanglement structures from resource states according to some embodiments. Network 1500 may be part of an example of an FBQC system. Network 1500 may include a plurality of network cells 1502 communicating with and controlled by a classical processing unit 1540. In some embodiments, each network cell 1502 may be implemented using a wafer-scale module described above. FIG. 15A shows the coupling among neighboring network cells 1502 in network 1500 through fusion devices 1520, 1522, and 1524. Each network cell 1502 may include an RSG 1510 that may produce a resource state that includes multiple entangled qubits in each clock cycle as described above with respect to FIG. 13. For example, each resource state generated in a clock cycle may include six peripheral qubits (qubits 1-6) that may be subject to fusion operations, and optionally one or more central qubits that may not be subject to fusion operations. Each network cell 1502 may also include a fusion device 1520 for resource state fusion in the x direction, a fusion device 1522 for resource state fusion in the y-direction, and a fusion device 1524 for resource state fusion in the time domain.

In the illustrated example, each network cell 1502 may provide two peripheral qubits, such as qubits 2 and 5, to fusion devices 1520 for fusion with peripheral qubits generated in the same clock cycle by neighboring network cells in the x direction as described above. RSG 1510 may also provide two peripheral qubits, such as qubits 3 and 6, to fusion devices 1522 for fusion with peripheral qubits generated in the same clock cycle by neighboring network cells in the y direction as described above. Therefore, resource states generated by network cells 1502 in a same clock cycle may be fused by space-like fusion operations to form a large, entangled state. In addition, each network cell 1502 may fuse two peripheral qubits, such as qubits 1 and 4 with qubits generated by the same RSG 1510 in different clock cycles as described above. For example, a qubit 1 generated by an RSG 1510 in a clock cycle may be delayed for a clock cycle by a delay line 1530 and may then be fused with a qubit 4 generated by the same RSG 1510 in the next clock cycle. In this way, resource states generated by network cells 1502 in multiple clock cycles may be fused by time-like fusion operations to form a large, entangled state.

FIG. 15B illustrates an example of a fusion device 1520 according to certain embodiments. Fusion devices 1522 and 1524 may have similar structures as fusion device 1520. Fusion device 1520 may have multiple settings that can be selected to reconfigure fusion device 1520 to implement different logical features. In the illustrated example, fusion device 1520 may include a switch 1526 and two or more fusion gates 1528 for implementing two or more different logical features. Each fusion gate 1528 may include, for example, one or more mode couplers (e.g., 50/50 beam splitters) as described above.

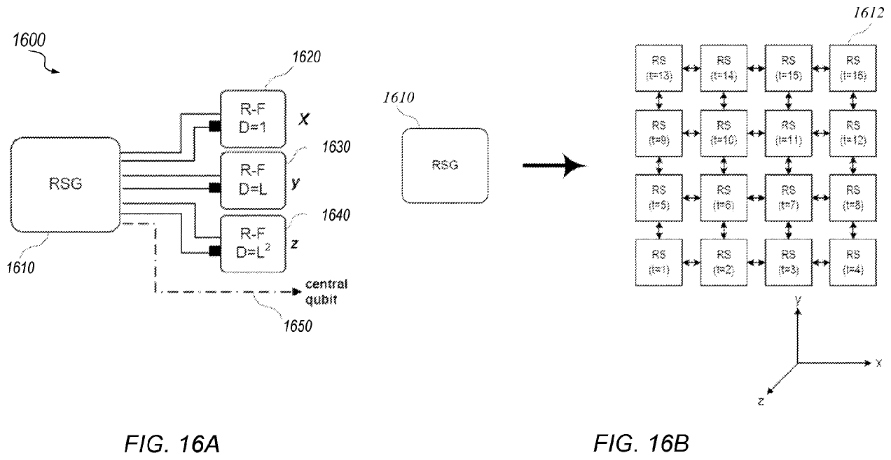

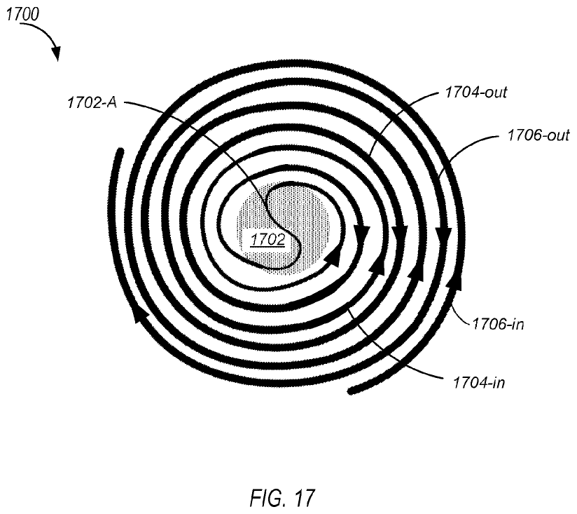

FIG. 16A illustrates a schematic of an example of a circuit 1600 for generating entanglement structures from resource states using a single resource state generator 1610 and time-like fusion operations according to certain embodiments. Circuit 1600 may be used to implement, for example, an MBQC system. In some embodiments, circuit 1600 may be implemented using a wafer-scale module described above. RSG 1610 may produce a resource state having six peripheral qubits (e.g., qubits 1-6) that are subject to fusion operations and optionally one or more central qubits 1650 that may not be subject to fusion operations in each clock cycle. A reconfigurable fusion circuit 1620 may delay a qubit (e.g., qubit 5) of each resource state generated by RSG 1610 by one clock cycle, and then fuse the delayed qubit with a qubit (e.g., qubit 2) of a resource state generated by RSG 1610 in the next clock cycle. A reconfigurable fusion circuit 1630 may delay a qubit (e.g., qubit 3) of each resource state generated by RSG 1610 by L clock cycles, and then fuse the delayed qubit with a qubit (e.g., qubit 6) of a resource state generated by RSG 1610 after L clock cycles. Reconfigurable fusion circuit 1640 may delay a qubit (e.g., qubit 1) of each resource state generated by RSG 1610 by L² clock cycles, and then fuse the delayed qubit with a qubit (e.g., qubit 4) of a resource state generated by RSG 1610 after L² clock cycles. The switching circuits within reconfigurable fusion circuits 1620-1640 may be controlled to provide desired behavior at the boundaries of the entangled structure. For instance, in order to form a layer having a planar topology, qubit 5 of the resource state generated at the Lth clock cycle may not be delayed and fused with qubit 2 of the resource state generated at the L+1th clock cycle.

Circuit 1600 may be used to generate layers of any size. In some embodiments, the maximum size may be determined based on the length of delay lines. A layer of size L² may be generated in L² clock cycles by circuit 1600. It should also be noted that, since many photons can coexist in a delay line, as few as three physical delay lines (e.g., three optical fibers or other waveguides of lengths corresponding to delays of 1, L. and L² clock cycles) may be used in circuit 1600. More generally, the number of physical delay lines used for a given implementation can depend on the particular structure of the resource state and dimensions of the layer. Accordingly, the hardware implementation using circuit 1600 can be significantly smaller than network 1500 describe above. But it may take a longer time to generate and operate on a given number of resource states using circuit 1600.

FIG. 16B illustrates a simplified example of generating a large, entangled state of qubits using circuit 1600 according to certain embodiments. FIG. 16B shows a conceptual illustration of generation of a layer of an entanglement structure. In the illustrated examples, the layer size may be L²=16 (L=4), but in practice L² can be much larger (e.g., about 10², about 10⁴, or about 10⁶). RSG 1610 may generate a single resource state 1612 in each clock cycle, and may generate L² resource states 1612 in L² clock cycles for generating a layer of an entanglement structure by circuit 1600 using time-like fusion operations. A three-dimensional entanglement structure can be generated using circuit 1600 by repeating the process of generating L² resource states and the time-like fusion operations for each layer.

FIG. 17 illustrates an example of a spiral optical delay device 1700 (e.g., a delay waveguide) and an optical path of light propagating in the optical delay device in accordance with some embodiments. This spiraling delay line is provided as merely one example, and other winding and/or meander delay geometries are possible without departing from the scope of the present disclosure. As shown, optical delay device 1700 includes a first multi-mode waveguide 1706-in providing a first portion of the optical path that spirals inward toward a center region 1702 of optical delay device 1700. First multi-mode waveguide 1706-in is coupled (e.g., physically, optically) to a first coupler 1704-in, which provides a second portion of the optical path that spirals further inward toward center region 1702 of optical delay device 1700. Optical delay device 1700 further includes a first single-mode waveguide 1702-A disposed (e.g., located) in center region 1702 and providing a third portion of the optical path through the center region. Optical delay device 1700 also includes a second coupler 1704-out providing a fourth portion of the optical path that spirals outward from center region 1702. Second coupler 1704-out is coupled (e.g., physically, optically) to a second multi-mode waveguide 1706-out, which provides a fifth portion of the optical path that spirals further outward from center region 1702. First single-mode waveguide 1702-A has a first end and a second end that is opposite to the first end. The first end of first single-mode waveguide 1702-A is coupled (e.g., physically, optically) to first coupler 1704-in and the second end of first single-mode waveguide 1702-A is coupled (e.g., physically or optically) to second coupler 1704-out. Lines with upward pointing arrows correspond to waveguides that spiral inward towards center region 1702 (e.g., first multi-mode waveguide 1706-in and first coupler 1704-in) and lines with downward pointing arrows correspond to waveguides that spiral outwards from center region 1702 (e.g., second multi-mode waveguide 1706-out and second coupler 1704-out).

First single-mode waveguide 1702-A is configured to allow propagation of light in a fundamental optical mode (e.g., TE₀). For example, first single-mode waveguide may have a width of one micrometer or less. Typically, propagation of light in higher order modes (e.g., optical modes that are not the fundamental optical mode, such as TE₁, TE₂, etc.) is prohibited in single-mode waveguides. In contrast, multi-mode waveguide 1706-in or 1706-out is configured to allow light to propagate, along the multi-mode waveguide, in one or more of a plurality of modes including the fundamental optical mode and higher order modes (e.g., light in a higher order mode as well as light in the fundamental optical mode can propagate through the multi-mode waveguide). For example, multi-mode waveguide 1706-in or 1706-out may have a width that is greater than one micrometer. In general, for propagation of light having a particular wavelength, a single-mode waveguide has a smaller width compared to a multi-mode waveguide.

First multi-mode waveguide 1706-in is configured to receive light, and to propagate the light along an inward spiral toward first coupler 1704-in. First coupler 1704-in is configured to receive the light from the first multi-mode waveguide, and to adiabatically couple the light to first single-mode waveguide 1702-A, which is configured to transmit the light toward second coupler 1704-out while changing the propagation direction of the light. Second coupler is configured to receive the light from first single-mode waveguide and to adiabatically couple the light to second multi-mode waveguide 1706-out, which is configured to propagate the light along an outward spiral to an output of optical delay device 1700. Arrows shown along the waveguides of optical delay device 1700 indicate the optical path (e.g., propagation direction, travel direction) of light in optical delay device 1700.

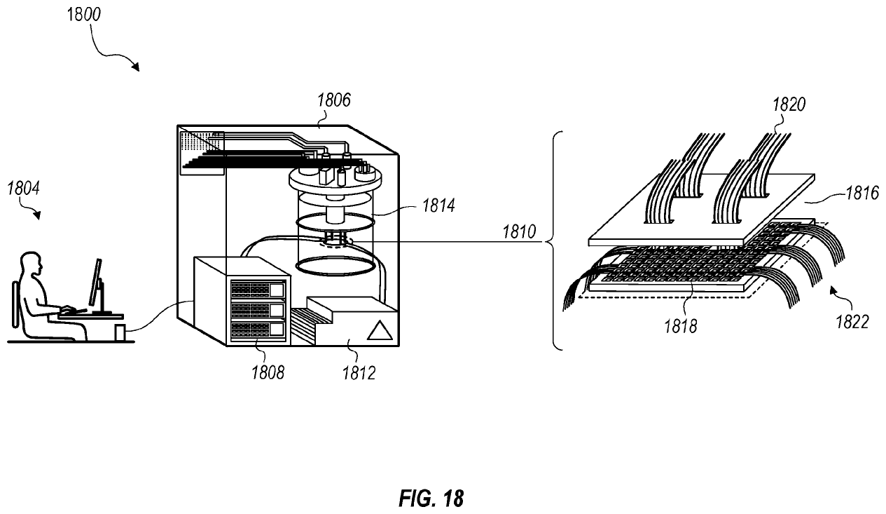

FIG. 18 is a simplified system block diagram of an example of a hybrid quantum computing system 1800 including electro-optic devices (e.g., switches) according to certain embodiments. In order to operate at low temperatures, for example liquid helium temperatures, embodiments of the present disclosure integrate the electro-optic switches discussed herein into a system that includes cooling systems. Thus, embodiments of the present disclosure provide a hybrid computing system, for example, as illustrated in FIG. 18. The hybrid quantum computing system 1800 includes a user interface device 1804 that is communicatively coupled to a hybrid quantum computing subsystem 1806. The user interface device 1804 can be any type of user interface device, e.g., a terminal including a display, keyboard, mouse, touchscreen and the like. In addition, the user interface device can itself be a computer such as a personal computer (PC), laptop, tablet computer and the like. In some embodiments, the user interface device 1804 provides an interface with which a user can interact with the hybrid quantum computing subsystem 1806. For example, the user interface device 1804 may run software, such as a text editor, an interactive development environment (IDE), command prompt, graphical user interface, and the like so that the user can program, or otherwise interact with, hybrid quantum computing subsystem 1806 to run one or more quantum algorithms. In other embodiments, the hybrid quantum computing subsystem 1806 may be pre-programmed and the user interface device 1804 may simply be an interface where a user can initiate a quantum computation, monitor the progress, and receive results from the hybrid quantum computing subsystem 1806. Hybrid quantum computing subsystem 1806 further includes a classical computing system 1808 coupled to one or more quantum computing chips 1810. In some examples, the classical computing system 1808 and the quantum computing chip 1810 can be coupled to other electronic components 1812, e.g., pulsed pump lasers, microwave oscillators, power supplies, networking hardware, etc.

In some embodiments that utilize cryogenic operation, the quantum computing system can be housed within a cryostat, e.g., cryostat 1814. In some embodiments, the quantum computing chip 1810 can include one or more constituent chips, e.g., hybrid electronic chip 1816 and integrated photonics chip 1818, which may include various waveguide structures and/or EO devices disclosed herein. Signals can be routed on-and off-chip any number of ways, e.g., via optical interconnects 1820 and via other electronic interconnects 1822. In addition, the hybrid quantum computing system 1800 may employ a quantum computing process, e.g., measurement-based quantum computing (MBQC) that employs one or more cluster states of qubits.

It will be apparent to those skilled in the art that substantial variations may be made in accordance with specific implementations. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

1. A device comprising:
an optical interposer including:
a first oxide layer; and
three or more optical waveguide layers in the first oxide layer, the three or more optical waveguide layers including:
a first waveguide layer including a first waveguide at a first distance below a top surface of the first oxide layer, the first waveguide characterized by a first thickness;
a second waveguide layer including a second waveguide at a second distance below the first waveguide, the second waveguide characterized by a second thickness, and the second waveguide partially overlapping the first waveguide; and
a third waveguide layer including a third waveguide at a third distance below the second waveguide, the third waveguide characterized by a third thickness, the third waveguide partially overlapping the second waveguide, the first thickness being greater than the second thickness, and the second thickness being greater than the third thickness; and
a first photonic integrated circuit (PIC) die bonded to the optical interposer, the first PIC die including a second oxide layer and a fourth waveguide in the second oxide layer, the second oxide layer bonded to the first oxide layer, and the fourth waveguide partially overlapping the first waveguide to optically couple to the first waveguide.

2. The device of claim 1, wherein the third distance is greater than the second distance and the second distance is greater than the first distance.

3. The device of claim 1, further comprising an optical fiber coupled to the third waveguide.

4. The device of claim 1, wherein the first PIC die includes a single photon source configured to generate individual photons.

5. The device of claim 1, wherein each one of the first waveguide layer, the second waveguide layer, and the third waveguide layer includes a pair of waveguides configured to transport photons in two or more quantum modes.

6. The device of claim 1, wherein:
the three or more optical waveguide layers comprise a fourth waveguide layer including a fifth waveguide at a fourth distance below the third waveguide;
the fifth waveguide is characterized by a fourth thickness, wherein the fifth waveguide partially overlaps the third waveguide;
the fourth distance is greater than the third distance and the fourth thickness is lower than the third thickness; and
the device further comprises an optical fiber coupled to the fifth waveguide.

7. The device of claim 6, wherein a distance between the fifth waveguide and the top surface of the first oxide layer and a distance between the fifth waveguide and a bottom surface of the first oxide layer are greater than a threshold value.

8. The device of claim 6, wherein:
the three or more optical waveguide layers further comprise a fifth waveguide layer including a sixth waveguide at a fifth distance below the fifth waveguide, wherein the sixth waveguide partially overlaps the fifth waveguide; and
the sixth waveguide is optically coupled to the optical fiber.

9. The device of claim 8, wherein a distance between the sixth waveguide and the top surface of the first oxide layer and a distance between the sixth waveguide and a bottom surface of the first oxide layer are greater than a threshold value.

10. The device of claim 6, further comprising a third oxide layer bonded to the optical interposer and on top of the fifth waveguide, wherein an optical field of a guided mode of the fifth waveguide extends into the third oxide layer.

11. The device of claim 6, wherein the fourth thickness is equal to or less than 100 nm.

12. The device of claim 6, wherein a delay of the fifth waveguide is between 10 ps and 50 ns.

13. The device of claim 1, wherein the third thickness is equal to or less than 100 nm.

14. The device of claim 1, wherein a delay of the third waveguide is between 10 ps and 50 ns.

15. The device of claim 1, wherein the first waveguide, the second waveguide, and the third waveguide are characterized by losses between 0.03 dB/m and 2 dB/m.

16. The device of claim 1, wherein a first coupling loss between the fourth waveguide and the first waveguide, a second coupling loss between the first waveguide and the second waveguide, or a third coupling loss between the second waveguide and the third waveguide is less than 20 mdB.

17. The device of claim 1, wherein overlapped portions of the first waveguide and the second waveguide are tapered.

18. The device of claim 1, wherein overlapped portions of the first waveguide and the second waveguide are longer than 100 m.

19. The device of claim 1, wherein a distance between the third waveguide and a bottom surface of the first oxide layer and a distance between the third waveguide and the top surface of the first oxide layer are greater than a threshold value.

20. The device of claim 1, further comprising a third oxide layer bonded to the optical interposer and on top of the third waveguide, wherein an optical field of a guided mode of the third waveguide extends into the third oxide layer.

21. The device of claim 1, further comprising a second PIC die bonded to the first oxide layer, the second PIC die including a fifth waveguide optically coupled to a sixth waveguide on the first waveguide layer of the optical interposer.

22. The device of claim 1, wherein the optical interposer comprises one or more of: a dispersion compensator, a polarization splitter, a polarization rotator, a light isolation structure, or a thermal isolation structure.

23. The device of claim 1, wherein the first PIC die comprises one or more of: a routing waveguide, a beam splitter, a grating coupler, a waveguide coupler, a filter, a delay line, a fusion gate, a polarization splitter, a polarization rotator, a switch, a single photon detector, a dispersion compensator, a photodetector for data communication, a heater, or a temperature sensor.

24-47. (canceled)
